(19) United States
(12) Patent Application Publication
(10) Pub. No.: US 2025/0260445 A1
(43) Pub. Date: Aug. 14, 2025

(54) BEAM PREDICTION METHOD AND APPARATUS, AND DEVICE AND STORAGE MEDIUM

(71) Applicant: Beijing Xiaomi Mobile Software Co., Ltd., Beijing (CN)

(72) Inventors: Mingju LI, Beijing (CN); Qin MU, Beijing (CN); Zhongyuan ZHAO, Beijing (CN); Jingyi WANG, Beijing (CN)

(73) Assignee: Beijing Xiaomi Mobile Software Co., Ltd., Beijing (CN)

(21) Appl. No.: 18/856,385

(22) PCT Filed: Apr. 13, 2022
(86) PCT No.: PCT/CN2022/086707

§ 371 Date: Oct. 11, 2024

(51) Int. Cl. H04B 7/0408; H04B 7/06; H04B 7/08

(52) U.S. Cl. CPC H04B 7/0408; H04B 7/0632; H04B 7/088

(57) ABSTRACT

The present application belongs to the technical field of communications. Disclosed are a beam prediction method and apparatus, and a device and a storage medium. The method includes: inputting, into a first beam prediction model, the beam quality of a first transmit beam which is obtained on the basis of a first receive beam, and obtaining, by means of the first beam prediction model, the beam quality of a second transmit beam based on the first receive beam, wherein the first receive beam is one of n receive beams of a terminal, and the first transmit beam comprises one or more transmit beams corresponding to the first receive beam; and reporting, to a network device, the beam quality of at least one of the first transmit beam and the second transmit beam.

### CROSS-REFERENCE TO RELATED APPLICATIONS

This application is a U.S. National Phase application of International Application No. PCT/CN2022/086707, filed on Apr. 13, 2022, the entire contents of which are incorporated herein by reference.

### TECHNICAL FIELD

The present disclosure relates to the field of communication technology, and in particular to a beam prediction method, apparatus, device and storage medium, BACKGROUND

With the development of wireless networks, various services have higher and higher requirements on beam performance, and the number of beams is increasing. During the communication process, the terminal needs to perform beam measurements on all beam pairs to complete beam management.

It should be noted that, information disclosed in the above background portion is provided only for better understanding of the background of the present disclosure, and thus it may contain information that does not form the prior art known by those ordinary skilled in the art.

### SUMMARY

The embodiments of the present application provide a beam prediction method, apparatus, device and storage medium. The technical solution is as follows:

According to one aspect of the present application, a beam prediction method is provided, which is applied to a terminal, and the method includes:
inputting a beam quality of a first transmission beam obtained based on a first reception beam into a first beam prediction model, and obtaining a beam quality of a second transmission beam based on the first reception beam through the first beam prediction model, wherein the first reception beam is one of n reception beams of the terminal, and the first transmission beam includes one or more transmission beams corresponding to the first reception beam; and
reporting a beam quality of at least one transmission beam in the first transmission beam and the second transmission beam to a network device.

According to one aspect of the present application, a beam prediction method is provided, which is applied to a network device, and the method includes:
inputting a beam quality of a first transmission beam obtained based on a first reception beam into a first beam prediction model, and obtaining a beam quality of a second transmission beam based on the first reception beam through the first beam prediction model, wherein the first reception beam is one of n reception beams of a terminal, and the first transmission beam includes one or more transmission beams corresponding to the first reception beam;
determining a target transmission beam according to a beam quality of at least one transmission beam in the first transmission beam and the second transmission beam.

According to one aspect of the present application, a beam prediction apparatus is provided, which includes:
a predicting module, configured to input a beam quality of a first transmission beam obtained based on a first reception beam into a first beam prediction model, and obtaining a beam quality of a second transmission beam based on the first reception beam through the first beam prediction model, wherein the first reception beam is one of n reception beams of a terminal, and the first transmission beam includes one or more transmission beams corresponding to the first reception beam; and
a sending module, configured to report abeam quality of at least one transmission beam in the first transmission beam and the second transmission beam to the network device.

According to one aspect of the present application, a beam prediction apparatus is provided, which includes:
a predicting module, configured to input a beam quality of a first transmission beam obtained based on a first reception beam into a first beam prediction model, and obtaining a beam quality of a second transmission beam based on the first reception beam through the first beam prediction model, wherein the first reception beam is one of n reception beams of a terminal, and the first transmission beam includes one or more transmission beams corresponding to the first reception beam; and
a determining module, configured to determine a target transmission beam according to a beam quality of at least one transmission beam in the first transmission beam and the second transmission beam.

According to one aspect of the present application, a terminal is provided, the terminal including a processor and a transceiver:
the processor is configured to input a beam quality of a first transmission beam obtained based on a first reception beam into a first beam prediction model, and obtaining a beam quality of a second transmission beam based on the first reception beam through the first beam prediction model, wherein the first reception beam is one of n reception beams of the terminal, and the first transmission beam includes one or more transmission beams corresponding to the first reception beam; and
the transceiver is configured to report a beam quality of at least one transmission beam in the first transmission beam and the second transmission beam to the network device.

According to one aspect of the present application, a network device is provided, the network device including a processor;
the processor is configured to input a beam quality of a first transmission beam obtained based on a first reception beam into a first beam prediction model, and obtaining a beam quality of a second transmission beam based on the first reception beam through the first beam prediction model, wherein the first reception beam is one of n reception beams of a terminal, and the first transmission beam includes one or more transmission beams corresponding to the first reception beam; and
determine a target transmission beam according to a beam quality of at least one transmission beam in the first transmission beam and the second transmission beam.

According to one aspect of the present application, a computer-readable storage medium is provided, in which a computer program is stored. The computer program is used to be executed by a processor to implement the beam prediction method as described above.

According to one aspect of the present application, a chip is provided, which includes a programmable logic circuit and/or program instructions, and when the chip is running, it is used to implement the beam prediction method as described above.

According to one aspect of the present application, a computer program product or a computer program is provided, the computer program product or the computer program including computer instructions, the computer instructions being stored in a computer-readable storage medium, and a processor reading and executing the computer instructions from the computer-readable storage medium to implement the beam prediction method as described above.

It is to be understood that both the foregoing general description and the following detailed description are exemplary and explanatory only and are not restrictive of the present disclosure.

### BRIEF DESCRIPTION OF THE DRAWINGS

In order to more clearly illustrate the technical solutions in the embodiments of the present application, the drawings required for use in the description of the embodiments will be briefly introduced below. Obviously, the drawings described below are only some embodiments of the present application. For ordinary technicians in this field, other drawings can be obtained based on these drawings without creative work.

FIG. 1 is a schematic diagram of a communication system provided by an exemplary embodiment of the present application;

FIG. 2 is a flow chart of a beam prediction method provided by an exemplary embodiment of the present application;

FIG. 3 is a flow chart of a beam prediction method provided by an exemplary embodiment of the present application;

FIG. 4 is a flow chart of a beam prediction method provided by an exemplary embodiment of the present application;

FIG. 5 is a flow chart of a beam prediction method provided by an exemplary embodiment of the present application;

FIG. 6 is a flow chart of a beam prediction method provided by an exemplary embodiment of the present application;

FIG. 7 is a flow chart of a beam prediction method provided by an exemplary embodiment of the present application;

FIG. 8 is a flow chart of a beam prediction method provided by an exemplary embodiment of the present application;

FIG. 9 is a flow chart of a beam prediction method provided by an exemplary embodiment of the present application;

FIG. 10 is a flowchart of training a beam prediction model provided by an exemplary embodiment of the present application;

FIG. 11 is a schematic diagram of a beam prediction apparatus provided by an exemplary embodiment of the present application;

FIG. 12 is a schematic diagram of a beam prediction apparatus provided by an exemplary embodiment of the present application;

FIG. 13 is a schematic diagram of the structure of a communication device provided by an exemplary embodiment of the present application.

### DETAILED DESCRIPTION

In order to make the objectives, technical solutions and advantages of the present application more clear, the implementation methods of the present application will be further described in detail below with reference to the accompanying drawings.

Exemplary embodiments will be described in detail herein, examples of which are shown in the accompanying drawings. Unless otherwise indicated, the same numbers in different drawings represent the same or similar elements when the following description refers to the drawings. The embodiments described in the following exemplary embodiments do not represent all embodiments consistent with the present application. Instead, they are merely examples of devices and methods consistent with some aspects of the present application as detailed in the appended claims.

The terms used in this application are only for the purpose of describing specific embodiments and are not intended to limit this application. The singular forms of “a”, “said” and “the” used in this application and the appended claims are also intended to include plural forms, unless the context clearly indicates other meanings. It should also be understood that the term “and/or” used in this article refers to and includes any or all possible combinations of one or more associated listed items.

It should be understood that although the terms first, second, third, etc. may be used in this application to describe various information, these information should not be limited to these terms. These terms are only used to distinguish the same type of information from each other. For example, without departing from the scope of this application, the first information may also be referred to as the second information, and similarly, the second information may also be referred to as the first information.

To ensure the coverage performance of wireless networks in the millimeter wave frequency band, network devices and terminals interact through narrow-angle shaped beams. Beam management can measure beam pairs in different directions and select the optimal beam pair to ensure the interaction quality between network devices and terminals. The 5th Generation Mobile Communication Technology New Radio (5G NR) greatly improves the coverage performance of wireless networks in the millimeter wave frequency band through beam management technology. In order to further reduce terminal overhead while ensuring beam management performance, the beam management mechanism has become an important topic that needs to be studied urgently.

In order to better standardize 50 NR beam management technology, the Third Generation Partnership Project (3GPP) has launched research projects on beam management. One of the basic components of beam management has been standardized, including the following aspects:
Beam scanning: the base station transmits beams in different directions in a time-division multiplexed manner to achieve coverage in a specific area. The respective beams correspond to different Channel State Information Reference Signals (CSI-RS), Synchronization Signa Blocks (SSB) and other signals. After beam scanning, the terminal can obtain the reference signal quality corresponding to the time-based beams in different directions.

Beam measurement: the terminal measures the reference signal and obtains the beam quality of the transmission beam direction corresponding to the reference signal by calculating the signal quality of the reference signal.

Beam reporting: the terminal reports the measurement information of the reference signal, which should at least include the reference signal identity (ID) and the corresponding measurement quality. The measurement quality includes the Layer-1 Reference Signal Received Power (L-RSRP) or the Layer-1 Signal to Interference plus Noise Ratio (L1-SINR).

Beam determination: the network device and the terminal select the transmit/reception beam. In the connected state, the network device shall determine the transmission beam based on the measurement information fed back by the terminal and indicate the beam to the terminal.

With the continuous development of wireless networks, various services have increasing requirements for beam performance. If the number of analog beams is large, the gain of analog beamforming will be improved, but the overhead of beam measurement and the complexity of beam management will be increased. If the number of analog beams is small, the gain of analog beamforming will be affected.

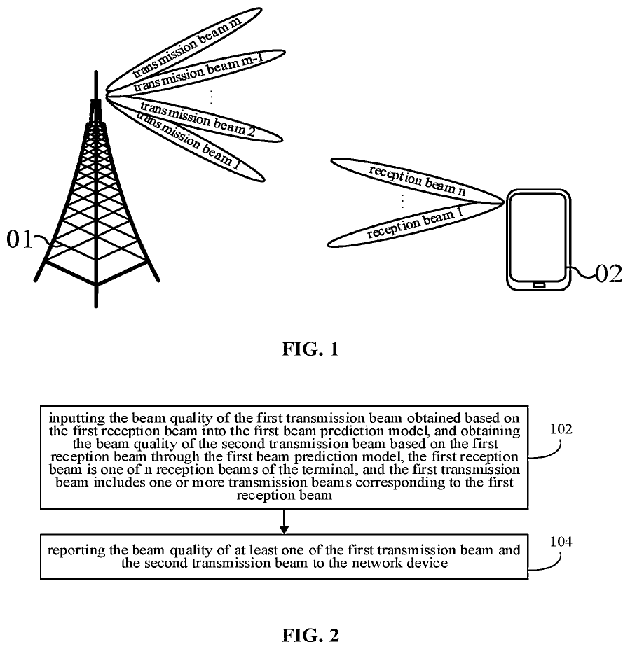

FIG. 1 shows a schematic diagram of a communication system provided by an exemplary embodiment of the present application. The communication system includes a network device 01 and a terminal 02.

In the embodiment, the network device 01 is a device deployed in an access network to provide a wireless communication function for the terminal 02. For the convenience of description, in the embodiment of the present application, the above-mentioned devices that provide a wireless communication function for the terminal 02 are collectively referred to as network devices.

A connection can be established between the network device 01 and the terminal 02 through an air interface, so that communication can be performed through the connection, including the interaction of signaling and data. There can be multiple network devices 01, and two adjacent network devices 01 can also communicate through wired or wireless means. The terminal 02 can switch between different network devices 01, that is, establish connections with different network devices 01.

The network device 01 may include various forms of macro base stations, micro base stations, relay stations, access points, etc. In systems using different wireless access technologies, the names of devices with network device functions may be different. For example, in a 50 NR system, it is called gNodeB or gNB. With the evolution of communication technology, the name “network device” may change.

The number of terminal 02 is usually multiple. The terminal 02 may include various handheld devices, vehicle-mounted devices, wearable devices, and computing devices with wireless communication functions, or other processing devices connected to a wireless modem, as well as various forms of user equipment (UE), mobile stations (MS), etc. For the convenience of description, in the embodiments of the present application, the above-mentioned devices are collectively referred to as terminals.

In the communication between the network device 01 and the terminal 02, beam management is required to establish and maintain a suitable beam pair. A beam pair includes a transmission beam of the network device 01 and a reception beam of the terminal 02. Different transmission beams have different transmission directions, and different reception beams have different reception directions.

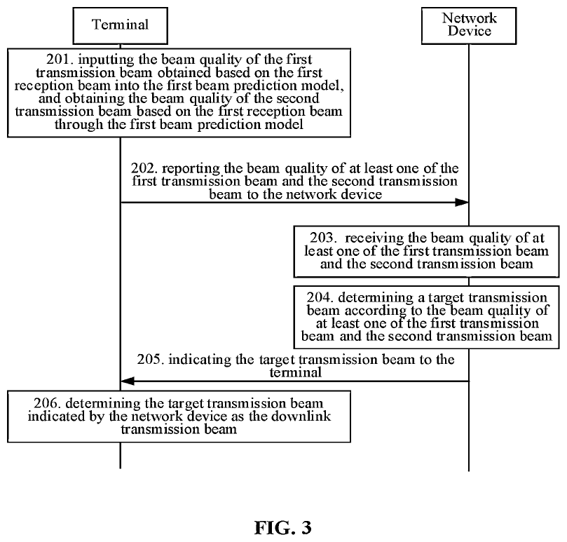

Schematically, referring to FIG. 2, the network device 01 corresponds to m transmission beams, each transmission beam corresponds to a reference signal; and the terminal 02 corresponds to n reception beams. Therefore, there are m×n beam pairs between network device 01 and terminal 02.

In the beam management process, if beam measurements are performed on m×n beam pairs, a large amount of reference signal resources will be consumed, and huge delays will be caused. Referring to the schematic diagram of the communication system shown in FIG. 1 and the above related knowledge, an embodiment of the present application provides a beam prediction method.

FIG. 2 shows a flowchart of abeam prediction method provided by an exemplary embodiment of the present application. The method is applied to the terminal 02 in FIG. 1. The method includes:

Step 102: inputting the beam quality of the first transmission beam obtained based on the first reception beam into the first beam prediction model, and obtaining the beam quality of the second transmission beam based on the first reception beam through the first beam prediction model.

Illustratively, the first reception beam is one of n reception beams of the terminal, and the first transmission beam includes one or more transmission beams corresponding to the first reception beam.

In the communication between the terminal and the network device, a reception beam of the terminal can form a beam pair with multiple transmission beams, wherein the first transmission beam includes one or more transmission beams corresponding to the first reception beam, and the second transmission beam includes the remaining transmission beams corresponding to the first reception beam except the first transmission beam.

Optionally, the transmission beams included in the first transmission beam and the second transmission beam are all transmission beams in the network device that correspond to the first reception beam.

Take the example that the terminal includes n reception beams and the network device includes m transmission beams. The first reception beam among the n reception beams corresponds to m transmission beams, and the first reception beam and the m transmission beams can constitute m beam pairs. In the embodiment, the first transmission beam includes one or more transmission beams among the m transmission beams, and the second transmission beam includes the remaining transmission beams among the m transmission beams except the first transmission beam. For example, the first transmission beam includes k transmission beams corresponding to the first reception beam, and the second transmission beam includes m-k transmission beams corresponding to the first reception beam, and the k transmission beams do not overlap with the ni-k transmission beams.

The beam prediction model is used to predict the beam quality of part of the transmission beams of the reception beam corresponding to the beam prediction model. The beam quality of the transmission beam can also be considered as the beam quality of the beam pair formed by the transmission beam. For example, the beam quality of the i-th transmission beam corresponding to the first reception beam can be the beam quality of the beam pair formed by the first reception beam and the i-th transmission beam.

Schematically, there is a one-to-one correspondence between the beam prediction model and the reception beam of the terminal. One reception beam corresponds to one beam prediction model, and different beam prediction models have different model structures and/or model parameters.

Taking into account the differences in different reception beams, each beam prediction model is only used to predict the beam quality of part of the transmission beams under the corresponding reception beam, thereby improving the accuracy of beam prediction. At the same time, it can also flexibly adapt to the measurement method of the terminal and adjust the input and output of the model to meet diverse service needs.

The n reception beams of the terminal correspond to n beam prediction models. Optionally, the first beam prediction model is a beam prediction model corresponding to the first reception beam among the n reception beams, and the first beam prediction model is used to predict the beam quality of part of the transmission beams corresponding to the first reception beam. Similarly, the i-th beam prediction model corresponds to the i-th reception beam among the n reception beams, and the i-th beam prediction model is used to predict the beam quality of part of the transmission beams corresponding to the i-th reception beam.

In an optional implementation scenario, different reception beams correspond to the same beam prediction model. Optionally, the first beam prediction model is a beam prediction model corresponding to each reception beam in the n reception beams. In this case, the first beam prediction model is used to predict the beam quality of part of the transmission beams corresponding to each reception beam of the terminal.

In the embodiment, the input of the first beam prediction model is the beam quality of the first transmission beam, and the output is the beam quality of the second transmission beam. Schematically, the terminal performs prediction processing the beam quality of the first transmission beam through the first beam prediction model to obtain the beam quality of the second transmission beam.

It should be understood that, when the terminal includes n reception beams, each reception beam corresponds to a beam prediction model. In the embodiment, based on the first reception beam, the terminal performs prediction processing on the beam quality of the first transmission beam through the first beam prediction model to obtain the beam quality of the second transmission beam corresponding to the first reception beam, and the second transmission beam includes the remaining transmission beams corresponding to the first reception beam except the first transmission beam. Similarly, based on the i-th reception beam, the terminal performs prediction processing on the beam quality of the first transmission beam corresponding to the i-th reception beam through the i-th beam prediction model to obtain the beam quality of the remaining transmission beams corresponding to the i-th reception beam.

Illustratively, the beam prediction model can be obtained by training based on the beam quality of a beam pair including a corresponding reception beam and multiple transmission beams.

Taking the first beam prediction model as an example, m beam pairs can be obtained according to the first reception beam and m transmission beams. The terminal performs beam measurement on each transmission beam to obtain the beam quality of each transmission beam, and determines the beam quality of each transmission beam as the beam quality of the corresponding beam pair; then, the terminal reports the beam quality of the m beam pairs to the network device, and the network device can perform data processing on the beam quality of the m beam pairs to form a beam measurement data set, and train the first beam prediction model based on the beam measurement training set to determine the model structure and model parameters of the first beam prediction model.

Step 104: reporting the beam quality of at least one of the first transmission beam and the second transmission beam to the network device.

After obtaining the beam quality of the second transmission beam based on the first reception beam through the first beam prediction model, the terminal may report the beam quality of at least one of the first transmission beam and the second transmission beam to the network device so that the network device can determine the target transmission beam.

Optionally, the beam quality of the first transmission beam is obtained by the terminal performing beam measurement on the first transmission beam using the first reception beam. The number of transmission beams included in the first transmission beam can be set according to actual needs. For example, the number of first transmission beams is determined according to the sampling rate of the beam measurement and the total number of beam pairs, or the number of first transmission beams is determined according to the sampling rate and the total number of transmission beams of the network device, and the total number of beam pairs is the product of the total number of transmission beams of the network device and the total number of reception beams of the terminal. Taking the example that the terminal includes n reception beams and the network device includes m transmission beams, there are m×n beam pairs between the network device and the terminal, and the total number of beam pairs is m×n.

After obtaining the beam quality of at least one of the first transmission beam and the second transmission beam, the network device may determine the target transmission beam according to the beam quality of at least one of the first transmission beam and the second transmission beam, and indicate the target transmission beam to the terminal, so that the terminal determines the target transmission beam as a downlink transmission beam and/or a downlink reception beam for beam management. The target transmission beam is the transmission beam corresponding to the optimal beam pair.

In the embodiment, the beam quality reported by the terminal to the network device may correspond to at least one transmission beam in the first transmission beam; may also correspond to at least one transmission beam in the second transmission beam; may also correspond to at least one transmission beam in the first transmission beam and at least one transmission beam in the second transmission beam.

In an optional implementation scenario, the terminal integrates the beam qualities of the first transmission beam and the second transmission beam corresponding to each reception beam in the n reception beams, determines the transmission beam with the best beam quality, and reports the beam quality of the transmission beam to the network device.

In another optional implementation scenario, the terminal reports the beam quality of the first transmission beam and the second transmission beam corresponding to each of the n reception beams to the network device. Subsequently, the network device integrates and processes the multiple beam qualities to determine the target transmission beam.

Exemplarily, the network device may determine the target transmission beam in the following manner: the terminal reports the beam quality of at least one of the first transmission beam and the second transmission beam to the network device; the network device sorts the beam qualities of at least one of the first transmission beam and the second transmission beam, determines the beam pair with the best beam quality as the optimal beam pair, and determines the transmission beam corresponding to the optimal beam pair as the target transmission beam.

It should be understood that the embodiment of the present application only takes the first reception beam as an example to describe the rediction of the terminal on the beam quality of part of the transmission beams (i.e., the second transmission beam) corresponding to the first reception beam; the prediction of the beam quality of the part of the transmission beams corresponding to other reception beams of the terminal is similar to the prediction process for the first reception beam, and the above steps can be referred to.

Taking the case where the terminal corresponds to n reception beams as an example, the terminal performs prediction process on the transmission beams based on different reception beams according to the beam prediction model corresponding to each reception beam, so as to obtain the beam quality of some transmission beams of different reception beams.

Illustratively, the following embodiments are still described by taking the first reception beam as an example, and the related processing of other reception beams of the terminal can refer to the first reception beam and will not be described in detail.

To summarize, in the beam prediction method provided in an embodiment of the present application, by inputting the beam quality of the first transmission beam into the first beam prediction model, the terminal can determine the beam quality of the second transmission beam, and report the beam quality of at least one of the first transmission beam and the second transmission beam to the network device, so that the network device can determine the target transmission beam.

In the embodiment, according to the beam prediction method provided in the embodiment of the present application, the terminal only needs to perform beam measurement on the first transmission beam, which avoids the terminal performing beam measurement on all transmission beams and reduces the number of beam measurements, thereby reducing the overhead and delay of beam management and reducing the complexity of beam management.

Optionally, different reception beams correspond to different beam prediction models, so that each beam prediction model is only used to predict the beam quality of part of the transmission beams of the corresponding reception beam, thereby improving the accuracy of beam prediction. At the same time, it can also flexibly adapt the measurement method of the terminal and adjust the input and output of the model to meet diverse service needs.

FIG. 3 shows a flowchart of a beam prediction method provided by an exemplary embodiment of the present application. The method is applied to the network device 01 and the terminal 02 in FIG. 1. The method includes:

Step 201: the terminal inputting the beam quality of the first transmission beam obtained based on the first reception beam into the first beam prediction model, and obtaining the beam quality of the second transmission beam based on the first reception beam through the first beam prediction model.

Illustratively, the first reception beam is one of n reception beams of the terminal, and the first transmission beam includes one or more transmission beams corresponding to the first reception beam.

Optionally, the transmission beams included in the first transmission beam and the second transmission beam are all transmission beams in the network device that correspond to the first reception beam.

The beam prediction model is used to predict the beam quality of part of the transmission beams of the reception beam corresponding to the beam prediction model. Schematically, the beam prediction model has a one-to-one correspondence with the reception beam of the terminal. One reception beam corresponds to one beam prediction model, and different beam prediction models have different model structures and/or model parameters. Optionally, the first beam prediction model is a beam prediction model corresponding to the first reception beam among the n reception beams.

In an optional implementation scenario, different reception beams correspond to the same beam prediction model. Optionally, the first beam prediction model is a beam prediction model corresponding to each reception beam in the n reception beams. In this case, the first beam prediction model is used to predict the beam quality of part of the transmission beams corresponding to each reception beam of the terminal.

In the embodiment, the input of the first beam prediction model is the beam quality of the first transmission beam, and the output is the beam quality of the second transmission beam. Schematically, the terminal performs prediction processing on the beam quality of the first transmission beam through the first beam prediction model to obtain the beam quality of the second transmission beam.

For the relevant description of the beam prediction model, please refer to the above content and will not be repeated here.

Step 202: the terminal reporting the beam quality of at least one of the first transmission beam and the second transmission beam to the network device.

After obtaining the beam quality of the second transmission beam based on the first reception beam through the first beam prediction model, the terminal may report the beam quality of at least one of the first transmission beam and the second transmission beam to the network device.

Optionally, the beam quality of the first transmission beam is obtained by the terminal performing beam measurement on the first transmission beam using the first reception beam.

Step 203: the network device receiving the beam quality of at least one of the first transmission beam and the second transmission beam reported by the terminal.

In the embodiment, the beam quality reported by the terminal to the network device may correspond to at least one transmission beam in the first transmission beam; may also correspond to at least one transmission beam in the second transmission beam; may also correspond to at least one transmission beam in the first transmission beam and at least one transmission beam in the second transmission beam.

In an optional implementation scenario, the terminal integrates the beam qualities of the first transmission beam and the second transmission beam corresponding to each reception beam in the n reception beams, determines the transmission beam with the best beam quality, and reports the beam quality of the transmission beam to the network device.

In another optional implementation scenario, the terminal reports the beam quality of the first transmission beam and the beam quality of the second transmission beam corresponding to each of the n reception beams to the network device. Subsequently, the network device integrates and processes the multiple beam qualities to determine the target transmission beam.

Step 204: the network device determining a target transmission beam according to the beam quality of at least one of the first transmission beam and the second transmission beam.

After acquiring the beam quality of at least one of the first transmission beam and the second transmission beam, the network device can determine the target transmission beam based on the beam quality of at least one of the first transmission beam and the second transmission beam, and indicate the target transmission beam to the terminal, so that the terminal can determine the target transmission beam as a downlink transmission beam and/or a downlink reception beam for beam management.

In the embodiment, the relevant description of the beam quality of the first transmission beam and the second transmission beam can be referred to the above content and will not be repeated here.

Step 205: the network device indicating the target transmission beam to the terminal.

Schematically, the optimal beam pair is determined according to the beam quality of at least one of the first transmission beam and the second transmission beam, and the target transmission beam corresponds to the optimal beam pair.

In the embodiment, the optimal beam pair can be determined in the following way: the terminal reports the beam quality of at least one of the first transmission beam and the second transmission beam to the network device; the network device sorts the beam qualities of at least one of the first transmission beam and the second transmission beam, and determines the beam pair with the best beam quality as the optimal beam pair.

Step 206: the terminal determining the target transmission beam indicated by the network device as the downlink transmission beam.

In an illustrative manner, the target transmission beam is one of the transmission beams of the network device. In the embodiment, when the optimal beam pair includes the first reception beam and any transmission beam, the target transmission beam is the transmission beam corresponding to the beam pair including the first reception beam; when the optimal beam pair includes other reception beams of the terminal and any transmission beam, the target transmission beam is the transmission beam corresponding to the beam pair including other reception beams of the terminal.

In the embodiment, the relevant descriptions of the optimal beam pair and the target transmission beam can be referred to the aforementioned content and will not be repeated here.

Illustratively, in an embodiment of the present application, the steps on the terminal side may independently become an embodiment of the beam prediction method, and the steps on the network device side may independently become an embodiment of the beam prediction method. The specific explanation of the steps of the beam prediction method and the steps of the sending method can refer to the above content and will not be repeated here.

To summarize, in the beam prediction method provided in an embodiment of the present application, by inputting the beam quality of the first transmission beam into the first beam prediction model, the terminal can determine the beam quality of the second transmission beam, and report the beam quality of at least one of the first transmission beam and the second transmission beam to the network device, so that the network device can determine the target transmission beam.

In the embodiment, according to the beam prediction method provided in the embodiment of the present application, the terminal only needs to perform beam measurement on the first transmission beam, which avoids the terminal performing beam measurement on all transmission beams and reduces the number of beam measurements, thereby reducing the overhead and delay of beam management and reducing the complexity of beam management.

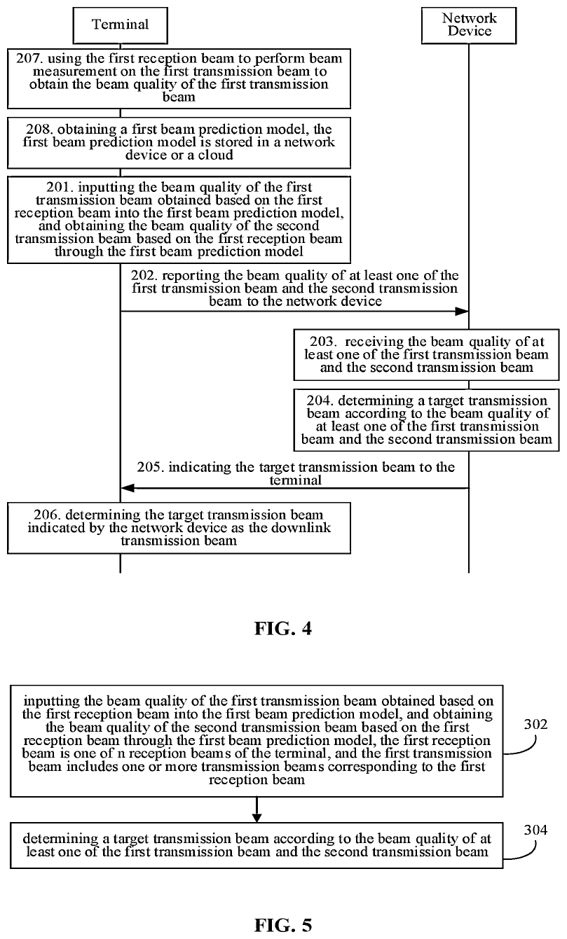

With reference to FIG. 3, FIG. 4 shows a flow chart of a beam prediction method provided by an exemplary embodiment of the present application. In the beam prediction method provided by the present application, step 207 and step 208 are also included before step 201. Step 207 and step 208 are both optional steps, which can be performed alternatively, can be performed simultaneously, can be performed sequentially, or can be performed out of order. The present application does not limit this. The relevant descriptions of step 207 and step 208 are as follows:

Step 207: the terminal using the first reception beam to perform beam measurement on the first transmission beam to obtain the beam quality of the first transmission beam.

Illustratively, the beam measurement performed on each transmission beam may be a measurement performed on a reference signal corresponding to each transmission beam. Optionally, the beam measurement on the transmission beam is performed based on a CSI-RS or SSB reference signal.

According to the above content, the first transmission beam includes one or more transmission beams corresponding to the first reception beam. The number of the first transmission beams needs to be determined before beam measurement, and the specific number can be set according to actual needs.

Optionally, the embodiment of the present application provides the following implementation manner. In the beam prediction method provided in the embodiment of the present application, before step 207, the followings are further included:

The terminal determines the number of first transmission beams according to the sampling rate of beam measurement and the total number of beam pairs, each beam pair includes a transmission beam of the network device and a reception beam of the terminal, and the total number of beam pairs is the product of the total number of transmission beams of the network device and the total number of reception beams of the terminal;

Alternatively, the terminal determines the number of first transmission beams according to the sampling rate and the total number of transmission beams of the network device.

The sampling rate of beam measurement is determined when the beam prediction model is trained. The sampling rate affects the number of input layer nodes of the beam prediction model. The larger the sampling rate, the larger the number of input layer nodes. In addition, the value of the sampling rate can be set according to actual needs.

Optionally, the sampling rate is a value greater than 0 and not greater than 1.

According to the foregoing, there are two ways to determine the number of first transmission beams: the number of first transmission beams is the product of the sampling rate and the total number of beam pairs; or, the number of first transmission beams is the product of the sampling rate and the total number of transmission beams of the network device.

For example, the terminal has n reception beams, the network device has m transmission beams, and the sampling rate is k. There are m×n beam pairs between the terminal and the network device, and the total number of beam pairs is m×n. The number of the first transmission beam can be determined in the following two ways:

Implementation 1: Unified confirmation of n reception beams. The number of the first transmission beams is m×n×k, which is the number of all beam pairs that need to be measured corresponding to the n reception beams. The number of transmission beams that need to be measured corresponding to each reception beam can then be determined based on this number.

Implementation 2: Separate confirmation of each reception beam. The number of the first transmission beams is m×k, which is the number of transmission beams that need to be measured corresponding to each reception beam.

According to the foregoing content, taking the first reception beam as an example, before the terminal predicts the beam quality of the second transmission beam based on the first reception beam, it is necessary to first determine the beam quality of the first transmission beam, which can be specifically implemented as follows:

Based on the first reception beam, the terminal selects a fixed number of transmission beams from multiple transmission beams corresponding to the first reception beam according to the sampling rate, and measures the quality of the reference signal corresponding to each selected transmission beam to obtain the beam quality of each transmission beam.

It should be understood that the processing of other reception beams of the terminal is similar to that of the first reception beam and will not be repeated here.

Step 208: the terminal obtaining a first beam prediction model.

Illustratively, the first beam prediction model is stored in a network device or a cloud or on a terminal side.

The first beam prediction model is a beam prediction model corresponding to the first reception beam. Before predicting the beam quality of the second transmission beam, the terminal needs to acquire the first beam prediction model in advance.

For example, the first beam prediction model is stored in a network device, the terminal sends an acquisition request to the network device, and the network device sends the first beam prediction model to the terminal according to the acquisition request; for another example, the first beam prediction model is stored in the cloud, and the terminal can download the first beam prediction model from the cloud; for another example, the first beam prediction model is directly stored on the terminal side, and the terminal can directly read it.

It should be understood that the acquisition of other beam prediction models is similar to that of the first beam prediction model and will not be described in detail.

In the embodiment, the relevant description of the beam prediction model can be referred to the above content and will not be repeated here.

Illustratively, in an embodiment of the present application, the steps on the terminal side may independently become an embodiment of the beam prediction method, and the steps on the network device side may independently become an embodiment of the beam prediction method. The specific explanation of the steps of the beam prediction method and the steps of the sending method can refer to the above content and will not be repeated here.

To summarize, in the beam prediction method provided in the embodiment of the present application, a method for obtaining the beam quality of the first transmission beam is provided: the terminal can use the first reception beam to perform beam measurement on the first transmission beam to obtain the corresponding beam quality.

Optionally, before performing beam measurement on the first transmission beam, the terminal may also determine the number of first transmission beams by the sampling rate of the beam measurement and the total number of beam pairs, or determine the number of first transmission beams by the sampling rate and the total number of transmission beams of the network device.

According to the foregoing disclosure, the beam prediction for the beam quality of the second transmission beam based on the first reception beam is implemented by the terminal side. In an optional implementation scenario, the beam prediction can also be implemented by the network device side, and the relevant description is as follows:

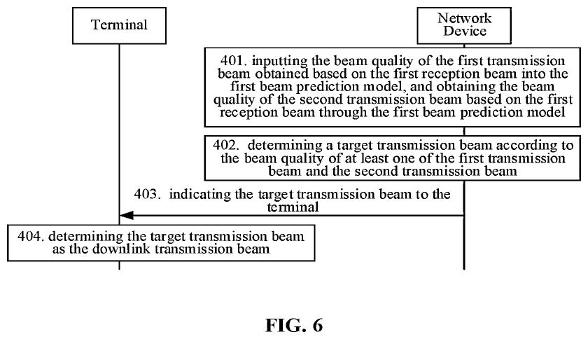

FIG. 5 shows a flowchart of a beam prediction method provided by an exemplary embodiment of the present application. The method is applied to the network device 01 in FIG.

### I. The Method Includes:

Step 302: inputting the beam quality of the first transmission beam obtained based on the first reception beam into the first beam prediction model, and obtaining the beam quality of the second transmission beam based on the first reception beam through the first beam prediction model.

Illustratively, the first reception beam is one of n reception beams of the terminal, and the first transmission beam includes one or more transmission beams corresponding to the first reception beam.

According to the foregoing, in the communication between the terminal and the network device, a reception beam of the terminal can form a beam pair with multiple transmission beams. The first transmission beam includes one or more transmission beams corresponding to the first reception beam, and the second transmission beam includes the remaining transmission beams other than the first transmission beam corresponding to the first reception beam.

Optionally, the transmission beams included in the first transmission beam and the second transmission beam are all transmission beams in the network device that correspond to the first reception beam.

The beam prediction model is used to predict the beam quality of part of the transmission beams of the reception beam corresponding to the beam prediction model. The beam quality of the transmission beam can also be considered as the beam quality of the beam pair including the transmission beam. For example, the beam quality of the i-th transmission beam corresponding to the first reception beam can be the beam quality of the beam pair formed by the first reception beam and the i-th transmission beam.

Schematically, the beam prediction model has a one-to-one correspondence with the reception beam of the terminal. One reception beam corresponds to one beam prediction model, and different beam prediction models have different model structures and/or model parameters. Optionally, the first beam prediction model is a beam prediction model corresponding to the first reception beam among the n reception beams.

In an optional implementation scenario, different reception beams correspond to the same beam prediction model. Optionally, the first beam prediction model is a beam prediction model corresponding to each reception beam in the n reception beams. In this case, the first beam prediction model is used to predict the beam quality of part of the transmission beams corresponding to each reception beam of the terminal.

The input of the first beam prediction model is the beam quality of the first transmission beam, and the output is the beam quality of the second transmission beam. Schematically, the network device performs prediction processing on the beam quality of the first transmission beam through the first beam prediction model to obtain the beam quality of the second transmission beam.

Illustratively, the beam prediction model can be obtained by training according to the beam quality of a beam pair including a corresponding reception beam and multiple transmission beams.

Illustratively, the relevant descriptions of the first reception beam, the first transmission beam, the first beam prediction model and the second transmission beam can be referred to the aforementioned content and will not be repeated here.

Step 304: determining a target transmission beam according to the beam quality of at least one of the first transmission beam and the second transmission beam.

In the embodiment, the beam quality of at least one of the first transmission beam and the second transmission beam is reported by the terminal to the network device. After obtaining the beam quality of at least one of the first transmission beam and the second transmission beam reported by the terminal, the network device can determine the target transmission beam accordingly.

Optionally, the beam quality of the first transmission beam is obtained by the terminal using the first reception beam to perform beam measurement on the first transmission beam. The number of transmission beams included in the first transmission beam can be set according to actual needs.

The target transmission beam may be determined based on the beam quality of at least one of the first transmission beam and the second transmission beam.

In the embodiment, since there are multiple beam pairs between the terminal and the network device, in order to facilitate the search, the placement order of the beam qualities of all beam pairs can be set. The network device can also sort the beam qualities of at least one of the first transmission beam and the second transmission beam according to the placement order of the beam qualities of all beam pairs, so as to determine the optimal beam pair, and determine the transmission beam corresponding to the optimal beam pair as the target transmission beam; then, the network device indicates the target transmission beam to the terminal, so that the terminal determines the target transmission beam as a downlink transmission beam and/or a downlink reception beam for beam management.

The placement order is used to indicate the correspondence between all beam pairs and beam qualities, indicating the association between different beams. Taking a beam pair ID table obtained according to the placement order as an example, in the process of predicting the beam quality through the first beam prediction model, the terminal can report the beam pair ID table to the network device, so that the network device sorts the beam quality of at least one of the first transmission beam and the second transmission beam according to the beam pair ID table, and the sorting order is determined by the beam pair ID table.

It should be understood that, in the process of predicting the beam quality by the first beam prediction model, the input of the first beam prediction model is the beam quality of one or more beam pairs corresponding to the first transmission beam, and the beam quality corresponding to the remaining beam pairs is set to a default value. The default value can be set according to actual needs.

Taking the example of a terminal corresponding to n reception beams, the target transmission beam can be determined in the following way: the network device sorts the beam qualities of the first transmission beam and the second transmission beam according to the placement order of the beam qualities of all beam pairs to obtain the beam qualities of all beam pairs; then, the network device determines the transmission beam corresponding to the beam pair with the best beam quality among all beam pairs as the target transmission beam.

In the embodiment, the relevant description of the optimal beam pair can be referred to the above content and will not be repeated here.

It should be understood that the embodiment of the present application only takes the first reception beam as an example and describes the prediction of the beam quality of part of the transmission beams (i.e., the second transmission beam) corresponding to the first reception beam on the network device side; the prediction of the beam quality of the part of the transmission beams corresponding to other reception beams of the terminal is similar to the prediction process for the first reception beam, and the above steps can be referred to.

Taking the case where the terminal corresponds to n reception beams as an example, the network device predicts the transmission beams based on different reception beams according to the beam prediction model corresponding to each reception beam, so as to obtain the beam quality of some transmission beams of different reception beams.

Illustratively, the following embodiments are still described by taking the first reception beam as an example, and the related processing of other reception beams of the terminal can refer to the first reception beam and will not be described in detail.

To summarize, in the beam prediction method provided in the embodiment of the present application, by inputting the beam quality of the first transmission beam into the first beam prediction model, the network device can determine the beam quality of the second transmission beam, so that the network device can determine the target transmission beam based on the beam quality of at least one of the first transmission beam and the second transmission beam.

In the embodiment, according to the beam prediction method provided in the embodiment of the present application, the terminal only needs to perform beam measurement on the first transmission beam, which avoids the terminal performing beam measurement on all transmission beams and reduces the number of beam measurements, thereby reducing the overhead and delay of beam management and reducing the complexity of beam management.

FIG. 6 shows a flowchart of abeam prediction method provided by an exemplary embodiment of the present application. The method is applied to the network device 01 and the terminal 02 in FIG. 1. The method includes:

Step 401: the network device inputting the beam quality of the first transmission beam obtained based on the first reception beam into the first beam prediction model, and obtaining the beam quality of the second transmission beam based on the first reception beam through the first beam prediction model.

Illustratively, the first reception beam is one ofn reception beams of the terminal, and the first transmission beam includes one or more transmission beams corresponding to the first reception beam.

Optionally, the transmission beams included in the first transmission beam and the second transmission beam are all transmission beams in the network device that correspond to the first reception beam.

The beam prediction model is used to predict the beam quality of part of the transmission beams of the reception beam corresponding to the beam prediction model. Schematically, the beam prediction model has a one-to-one correspondence with the reception beam of the terminal. One reception beam corresponds to one beam prediction model, and different beam prediction models have different model structures and/or model parameters. Optionally, the first beam prediction model is a beam prediction model corresponding to the first reception beam among the n reception beams.

In an optional implementation scenario, different reception beams correspond to the same beam prediction model. Optionally, the first beam prediction model is a beam prediction model corresponding to each reception beam in the n reception beams. In this case, the first beam prediction model is used to predict the beam quality of part of the transmission beams corresponding to each reception beam of the terminal.

In the embodiment, the input of the first beam prediction model is the beam quality of the first transmission beam, and the output is the beam quality of the second transmission beam. Schematically, the network device performs prediction processing on the beam quality of the first transmission beam through the first beam prediction model to obtain the beam quality of the second transmission beam.

For the relevant description of the beam prediction model, please refer to the above content and will not be repeated here.

Step 402: the network device determining a target transmission beam according to the beam quality of at least one of the first transmission beam and the second transmission beam.

After acquiring the beam quality of at least one of the first transmission beam and the second transmission beam, the network device can determine the target transmission beam based on the beam quality of at least one of the first transmission beam and the second transmission beam, and indicate the target transmission beam to the terminal, so that the terminal can determine the target transmission beam as a downlink transmission beam and/or a downlink reception beam for beam management.

In the embodiment, the relevant description of the beam quality of the first transmission beam and the second transmission beam can be referred to the above content and will not be repeated here.

Step 403: the network device indicating the target transmission beam to the terminal.

Schematically, the optimal beam pair is determined according to the beam quality of at least one of the first transmission beam and the second transmission beam, and the target transmission beam corresponds to the optimal beam pair.

In the embodiment, the determination of the optimal beam pair can refer to the above content and will not be repeated here.

According to the foregoing, each beam pair includes a reception beam of the terminal and a transmission beam of the network device. After determining the optimal beam pair, the network device determines the transmission beam in the optimal beam pair as the target transmission beam, which has the best beam quality; then, the network device indicates the target transmission beam to the terminal so that the terminal determines it as the downlink transmission beam, and/or determines the reception beam corresponding to the target transmission beam as the downlink reception beam.

Illustratively, the target transmission beam is one of the transmission beams of the network device.

In the embodiment, when the optimal beam pair includes the first reception beam and any transmission beam, the target transmission beam is the transmission beam corresponding to the beam pair including the first reception beam; when the optimal beam pair includes other reception beams of the terminal and any transmission beam, the target transmission beam is the transmission beam corresponding to the beam pair including other reception beams of the terminal.

Step 404: the terminal determining the target transmission beam as the downlink transmission beam.

For the description of the optimal beam pair and the target transmission beam, please refer to the above content and will not be repeated here.

Optionally, the terminal determines the reception beam corresponding to the target transmission beam as the downlink reception beam.

Illustratively, in an embodiment of the present application, the steps on the terminal side may independently become an embodiment of the beam prediction method, and the steps on the network device side may independently become an embodiment of the beam prediction method. The specific explanation of the steps of the beam prediction method and the steps of the sending method can refer to the above content and will not be repeated here.

To summarize, in the beam prediction method provided in the embodiment of the present application, by inputting the beam quality of the first transmission beam into the first beam prediction model, the network device can determine the beam quality of the second transmission beam, and determine the target transmission beam based on the beam quality of at least one of the first transmission beam and the second transmission beam.

In the embodiment, according to the beam prediction method provided in the embodiment of the present application, the terminal only needs to perform beam measurement on the first transmission beam, which avoids the terminal performing beam measurement on all transmission beams and reduces the number of beam measurements, thereby reducing the overhead and delay of beam management and reducing the complexity of beam management.

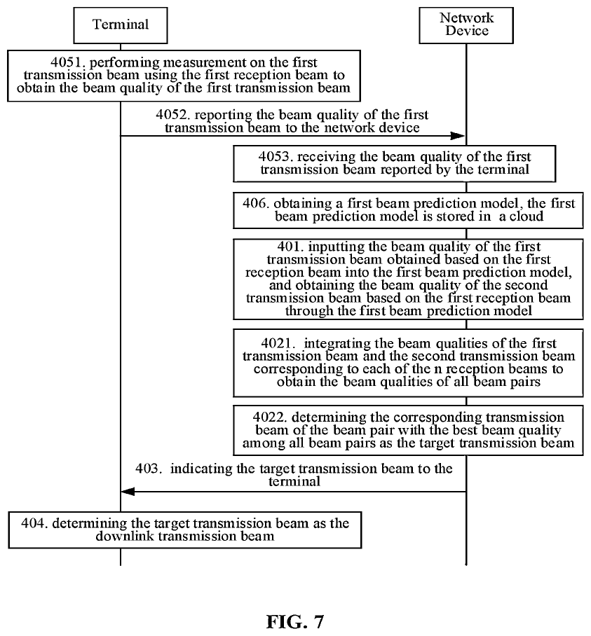

With reference to FIG. 6, FIG. 7 shows a flowchart of a beam prediction method provided by an exemplary embodiment of the present application. In the beam prediction method provided by the present application, steps 4051-406 are also included before step 401, and step 402 can be implemented as steps 4021 and 4022. In the embodiment, step 407 and steps 4051-406 are all optional steps, which can be executed alternatively, can be executed simultaneously, can be executed sequentially, or can be executed out of order, and the present application does not limit this. In the embodiment, the relevant descriptions of steps 4051-406, step 4021 and step 4022 are as follows:

Step 4051: the terminal using the first reception beam to obtain the beam quality of the first transmission beam.

Illustratively, the beam measurement performed on each transmission beam may be a measurement performed on a reference signal corresponding to each transmission beam. Optionally, the beam measurement on the transmission beam is performed based on a CSI-RS or SSB reference signal.

Step 4052: the terminal reporting the beam quality of the first transmission beam to the network device.

In the embodiment, the relevant descriptions of beam measurement and beam quality of the first transmission beam can be referred to the above content and will not be repeated here.

Step 4053: the network device receiving the beam quality of the first transmission beam reported by the terminal.

Illustratively, the beam quality of the first transmission beam is obtained by the terminal by performing beam measurement on the first transmission beam using the first reception beam.

According to the above disclosure, the first transmission beam includes one or more transmission beams corresponding to the first reception beam. The number of the first transmission beams needs to be determined before beam measurement, and the specific number can be set according to actual needs.

Optionally, the number of the first transmission beams can be implemented in the following two ways:

The number of the first transmission beams is determined according to a sampling rate of beam measurement and a total number of beam pairs, each beam pair includes a transmission beam of the network device and a reception beam of the terminal, and the total number of beam pairs is the product of the total number of transmission beams of the network device and the total number of reception beams of the terminal;

Alternatively, the number of the first transmission beams is determined according to the sampling rate and the total number of transmission beams of the network device.

The sampling rate of beam measurement is determined when the beam prediction model is trained. The sampling rate affects the number of input layer nodes of the beam prediction model. The larger the sampling rate, the larger the number of input layer nodes. In addition, the value of the sampling rate can be set according to actual needs.

Optionally, the sampling rate is a value greater than 0 and not greater than 1.

According to the foregoing, there are two ways to determine the number of first transmission beams: the number of first transmission beams is the product of the sampling rate and the total number of beam pairs; or, the number of first transmission beams is the product of the sampling rate and the total number of transmission beams of the network device.

It should be understood that the processing of other reception beams of the terminal is similar to that of the first reception beam and will not be repeated here.

Step 406: the network device obtaining a first beam prediction model.

Illustratively, the first beam prediction model is stored in a network device or a cloud or on a terminal side.

Before the network device predicts the beam quality of the second transmission beam, it needs to obtain the first beam prediction model in advance. For example, the first beam prediction model is stored in the network device, and the network device can directly read it; for another example, the first beam prediction model is stored in the cloud, and the network device can download the first beam prediction model from the cloud; for another example, the first beam prediction beam is directly stored on the terminal side, and the network device can require the terminal to report the first beam prediction model.

It should be understood that the acquisition of other beam prediction models is similar to that of the first beam prediction model and will not be described in detail.

In the embodiment, the relevant description of the beam prediction model can be referred to the above content and will not be repeated here.

After acquiring the first beam prediction model, the network device may obtain the beam quality of the second transmission beam based on the first reception beam according to the first beam prediction model and the beam quality of the first transmission beam. Subsequently, the network device may determine the target transmission beam according to the received beam quality of the first transmission beam and the predicted beam quality of the second transmission beam. Determining the target transmission beam pair may be implemented as steps 4021 and 4022, which are described in detail as follows:

Step 4021: the network device integrating the beam qualities of the first transmission beam and the second transmission beam corresponding to each of the n reception beams to obtain the beam qualities of all beam pairs.

In the embodiment, the beam quality of the first transmission beam is reported by the terminal, and the beam quality of the first transmission beam is a measured value obtained by the terminal performing beam measurement on the first transmission beam; the beam quality of the second transmission beam is obtained by the network device performing prediction processing based on the first beam prediction model, and the beam quality of the second transmission beam is the predicted value of the second transmission beam obtained by the network device performing prediction processing.

Taking the network device corresponding to m transmission beams as an example, the first transmission beam includes k transmission beams among the m transmission beams, and the second transmission beam includes m-k transmission beams among the m transmission beams. The beam quality of the first transmission beam is a measurement value obtained by the terminal performing beam measurement on the k transmission beams; the beam quality of the second transmission beam is a prediction value of the beam quality of the n-k transmission beams obtained by the network device through the first prediction model by inputting the beam quality of the k transmission beams into the first beam prediction model.

Optionally, in the case where the network device determines the target transmission beam according to the beam qualities of the first transmission beam and the second transmission beam, step 4021 may be implemented as follows:

The network device sorts the beam qualities of the first transmission beam and the second transmission beam according to the placement order of the beam qualities of all beam pairs.

In the embodiment, the placement order of the beam qualities of all beam pairs may be determined according to actual needs.

Optionally, before performing beam measurement on the first transmission beam, the terminal may also determine a placement order of the beam quality of each beam pair in all beam pairs.

For example, if the terminal has n reception beams and the network device has m transmission beams, the terminal can perform grouping according to the reception beams, and under each of the n reception beams, the corresponding n transmission beams are traversed in turn to form a beam pair ID. Each beam pair ID corresponds to a reception beam of the terminal and a transmission beam of the network device, and the i-th beam pair ID corresponds to the beam quality of the i-th beam pair.

Illustratively, after determining the placement order of the beam qualities of each beam pair in all beam pairs, a beam pair ID table may be obtained.

It should be understood that the placement order is used to indicate the correspondence between all beam pairs and beam qualities, indicating the association between different beams. Taking the beam pair ID table as an example, according to the beam pair ID table, the terminal and/or network device can determine the placement position of the beam quality of each beam pair, as well as the reception beam and transmission beam corresponding to each beam quality. As a result, the terminal and/or network device can know the correlation between the transmission beam and the reception beam corresponding to each beam quality input by the model, so as to better predict the beam quality of the remaining beams.

Illustratively, during the training process of the first beam prediction model and the prediction process of the beam quality, the beam qualities of all beam pairs need to be placed according to the beam pair ID table to facilitate query by the terminal and/or network device.

In the embodiment, in the process of predicting the beam quality by the first beam prediction model, the input of the first beam prediction model is the beam quality of one or more beam pairs corresponding to the first transmission beam, and the beam quality corresponding to the remaining beam pairs is set to a default value, and the default value can be set according to actual needs.

According to the above example, the beam pair ID table is as follows:

| Reception | | Beam Pair | Beam quality of beam |
|---|---|---|---|
| beam | Transmission beam | ID | pairs |
| Reception | Transmission beam 1 | 1 | x₁ |
| beam 1 | . . . | . . . | . . . |
| | Transmission beam m | m | xₘ |
| Reception | Transmission beam 1 | m + 1 | xₘ₊₁ |
| beam 2 | . . . | . . . | . . . |
| | Transmission beam m | 2m | x₂ₘ |
| . . . | . . . | . . . | . . . |
| Reception | Transmission beam 1 | (n − 1)m + 1 | x₍ₙ₋₁₎ₘ₊₁ |
| beam n | . . . | . . . | . . . |
| | Transmission beam m | nm | xₙₘ |

The above example is based on determining the placement order based on the reception beam, and n grouped beam pair IDs can be obtained. One grouped beam pair ID corresponds to one reception beam.

It should be understood that, in an optional implementation scenario, the placement order can also be determined based on the transmission beam to obtain m grouped beam pairs ID, and one grouped beam pair ID corresponds to one transmission beam. Accordingly, in an optional implementation scenario, the first beam prediction model can also be a beam prediction model corresponding to the first transmission beam of the m transmission beams of the network device, or a beam prediction model corresponding to each of the in transmission beams. In this case, the positions of the transmission beam and the reception beam in the embodiment given in the present application are interchanged, so that the terminal only needs to perform beam measurement on part of the reception beams to achieve the determination and adjustment of the uplink beam.

Optionally, the network device can also receive the beam pair ID table reported by the terminal to obtain the placement order of the beam qualities of all beam pairs.

According to the placement order of the beam qualities of all beam pairs, the network device can sort the beam qualities of the first transmission beam and the second transmission beam according to the beam pair ID table to obtain the beam qualities of all beam pairs.

Step 4022: the network device determining the corresponding transmission beam of the beam pair with the best beam quality among all beam pairs as the target transmission beam.

After obtaining the beam qualities of all beam pairs, the network device may determine the beam pair with the best quality as the optimal beam pair, and indicate its corresponding target transmission beam to the terminal, so that the terminal can determine the downlink transmission beam and/or downlink reception beam.

Illustratively, in an embodiment of the present application, the steps on the terminal side may independently become an embodiment of the beam prediction method, and the steps on the network device side may independently become an embodiment of the beam prediction method. The specific explanation of the steps of the beam prediction method and the steps of the sending method can refer to the above content and will not be repeated here.

To summarize, in the beam prediction method provided in the embodiment of the present application, a method for obtaining the beam quality of the first transmission beam is given: the terminal can use the first reception beam to perform beam measurement on the first transmission beam to obtain the corresponding beam quality and feed it back to the network device.

Optionally, an embodiment of the present application also provides a specific implementation method for determining the target transmission beam: the network device integrates the beam qualities of the first transmission beam and the second transmission beam, and determines the transmission beam corresponding to the beam pair with the best beam quality as the target transmission beam.

The following embodiments take the training of the first beam prediction model as an example to describe the training process of the beam prediction model. The training of other beam prediction models is similar to that of the first beam prediction model and can be used as a reference and will not be repeated here. In the embodiment, the terminal reports the beam quality of all beam pairs to the network device, and the network device processes the beam quality of all beam pairs and trains to obtain the first beam prediction model.

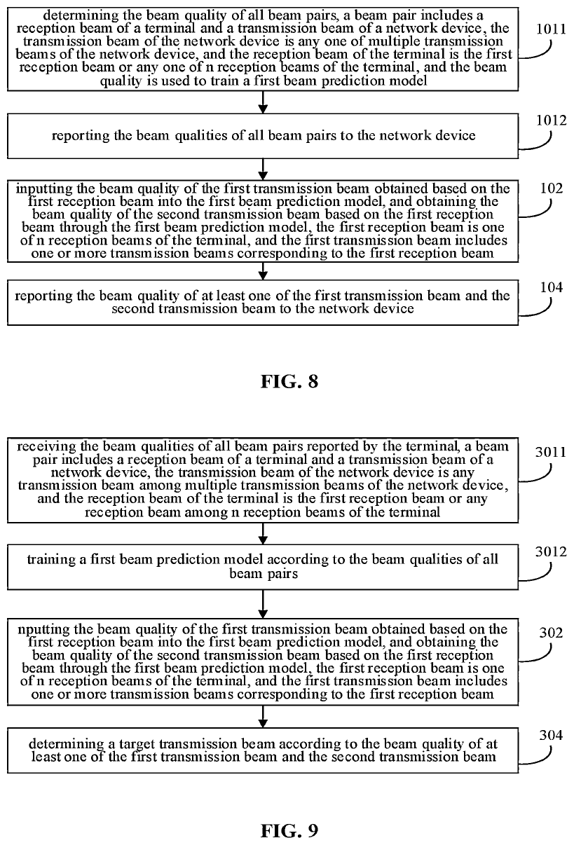

With reference to FIG. 2, FIG. 8 shows a flowchart of a beam prediction method provided by an exemplary embodiment of the present application, and provides a process in which a terminal reports the beam quality of all beam pairs. The beam prediction method provided in the embodiment of the present application also includes;

Step 1011: determining the beam quality of all beam pairs.

Schematically, a beam pair includes a reception beam of a terminal and a transmission beam of a network device, the transmission beam of the network device is any one of multiple transmission beams of the network device, and the reception beam of the terminal is the first reception beam or any one of n reception beams of the terminal, and the beam quality is used to train a first beam prediction model.

On each of the n reception beams, the terminal performs beam measurement on the corresponding transmission beam to obtain the beam quality of each transmission beam, and marks it as the beam quality of the corresponding beam pair.

Optionally, step 1011 may be implemented as follows:

Using the first reception beam of the terminal, all the transmission beams of the network device are measured to obtain the beam quality corresponding to each beam pair;

Alternatively, each reception beam of the terminal is used to measure all the transmission beams of the network device respectively to obtain the beam quality corresponding to each beam pair.

Optionally, beam measurement for a transmission beam is performed based on a CSI-RS or SSB reference signal.

According to the foregoing content, the first beam prediction model may be a beam prediction model corresponding to the first reception beam among the n reception beams, or may be a beam prediction model corresponding to each reception beam among the n reception beams.

The corresponding reception beams are different, and the training of the first beam prediction model is also different.

Taking the example that the terminal corresponds to n reception beams and the network device corresponds to m transmission beams, when the first beam prediction model corresponds to the first reception beam, the first beam prediction model is trained based on the beam quality of m beam pairs including the first reception beam and the m transmission beams; when the first beam prediction model corresponds to each reception beam, the first beam prediction model is trained based on the beam quality of m×n beam pairs including n reception beams and m transmission beams.

Taking the first beam prediction model being corresponding to the first reception beam as an example, based on n reception beams, the terminal measures all the transmission beams of the network device to obtain the beam quality corresponding to each beam pair.

For example, based on the first reception beam, the terminal performs beam measurement on the m transmission beams of the network device to obtain the beam qualities corresponding to the m beam pairs; then, based on the remaining n−1 reception beams, the terminal sequentially performs beam measurement on the in transmission beams to obtain the beam qualities corresponding to the (n−1)×m beam pairs; the terminal integrates the measurements to obtain the beam qualities corresponding to the n×m beam pairs.

Step 1012: reporting the beam qualities of all beam pairs to the network device.

Schematically, a beam pair includes a reception beam of a terminal and a transmission beam of a network device, the transmission beam of the network device is any transmission beam among multiple transmission beams of the network device, and the reception beam of the terminal is the first reception beam or any reception beam among n reception beams of the terminal.

In the embodiment, the relevant description of the beam pair can be referred to the above content and will not be repeated here.

In summary, the beam prediction method provided in the embodiment of the present application provides an implementation method for the terminal to report the beam qualities of all beam pairs, so as to facilitate the network device to train the beam prediction model.

With reference to FIG. 2, FIG. 9 shows a flowchart of a beam prediction method provided by an exemplary embodiment of the present application, and provides a process in which a terminal reports the beam quality of all beam pairs. The beam prediction method provided in the embodiment of the present application also includes:

Step 3011: receiving the beam qualities of all beam pairs reported by the terminal.

Schematically, a beam pair includes a reception beam of a terminal and a transmission beam of a network device, the transmission beam of the network device is any transmission beam among multiple transmission beams of the network device, and the reception beam of the terminal is the first reception beam or any reception beam among n reception beams of the terminal.

In the embodiment, the relevant description of the beam pair can be referred to the above content and will not be repeated here.

Step 3012: training a first beam prediction model according to the beam qualities of all beam pairs.

After receiving the beam qualities of all beam pairs reported by the terminal, the network device can obtain the beam quality of each beam pair: then, the network device can process the beam qualities of all beam pairs to form a beam measurement data set, and train a beam prediction model based on the beam measurement data set.

According to the foregoing, in another optional implementation scenario, one beam prediction model corresponds to one reception beam, and the i-th beam prediction model is a beam prediction model corresponding to the i-th reception beam among the n reception beams. The following takes the case where the first beam prediction model is a beam prediction model corresponding to the first reception beam as an example to provide an optional implementation method for training the first beam prediction model:

Assume that the terminal has n reception beams and the network device has m transmission beams.

The network device processes the beam qualities of all beam pairs to form a beam measurement data set; the network device divides the m beam pairs formed by the first reception beam to form a first group; then, the network device determines the model structure and model parameters of the first prediction model, and trains the first beam prediction model through the first group.

It should be understood that, similar to the first beam prediction model, the i-th beam prediction model corresponds to the i-th reception beam. The network device trains the i-th beam prediction model through the i-th group among the n groups, the division of the i-th group is similar to the division of the first group, and the training process of the i-th beam prediction model is similar to the training process of the first beam prediction model, which will not be repeated.

In another optional implementation scenario, the first beam prediction model is a beam prediction model corresponding to each of the n reception beams. Another optional implementation manner of training the first beam prediction model is given below:

Assume that the terminal has n reception beams and the network device has m transmission beams.

The network device still processes the beam qualities of all beam pairs to form a beam measurement data set; then, the network device divides the beam measurement data set into n non-overlapping groups according to the placement order of the beam qualities of each beam pair in all beam pairs; then, the network device determines the model structure and model parameters of the first prediction model, and trains the first beam prediction model through the a groups.

In the embodiment, the placement positions of the beam qualities of all beam pairs are determined according to the placement order. Taking a beam pair ID table obtained according to the placement order as an example, during the training process of the first beam prediction model, the network device can sort all beam pairs according to the beam pair ID table, and the placement position of the beam quality of each beam pair is fixed.

Optionally, the model structure of the first beam prediction model may be determined as follows;

Regarding the process of determining the number of layers and nodes of the model, the number of input layer nodes is set to M, which represents the number of measured beam pairs in the input model. This value is related to the sampling rate k and the total number of beam pairs C. The larger the sampling rate, the more beam pairs the user measures, and the larger the number of input layer nodes is set; the number of output layer nodes is set to N, which depends on the total number of beam pairs C. The larger the total number of beam pairs, the larger the number of output layer nodes is set; the number of hidden layers is set to S, and the number of nodes in each hidden layer is set to L. The number of hidden layers needs to consider factors such as model size and model generalization ability.

Regarding the process of determining the inter-layer connection, the hidden layer and the input layer are fully connected, and the activation function can use the linear rectification function (Relu function); the hidden layer and the hidden layer are fully connected, and the activation function can use the Relu function; the hidden layer and the output layer are partially connected, and the activation function can use the normalized exponential function (Softmax function) or the S-type function (Sigmoid function).

For the process of determining the loss function used, the mean-square error (MSE) loss function, the mean absolute error (MAE) loss function, the Huber loss function, etc. can be used.

For the process of determining the hyperparameters of the network model, the number of learning rounds is set to T. The setting of the number of learning rounds needs to weigh the impact of the model training speed, training cost and model training accuracy. The learning rate is set to α and β. The method of weight initialization selects random weight initialization.

Subsequently, the network device may train a first beam prediction model using the first group or n groups.

In summary, in the beam prediction method provided in the embodiment of the present application, an implementation method for beam prediction model training is provided to facilitate the terminal or network device to perform related processing of beam prediction.

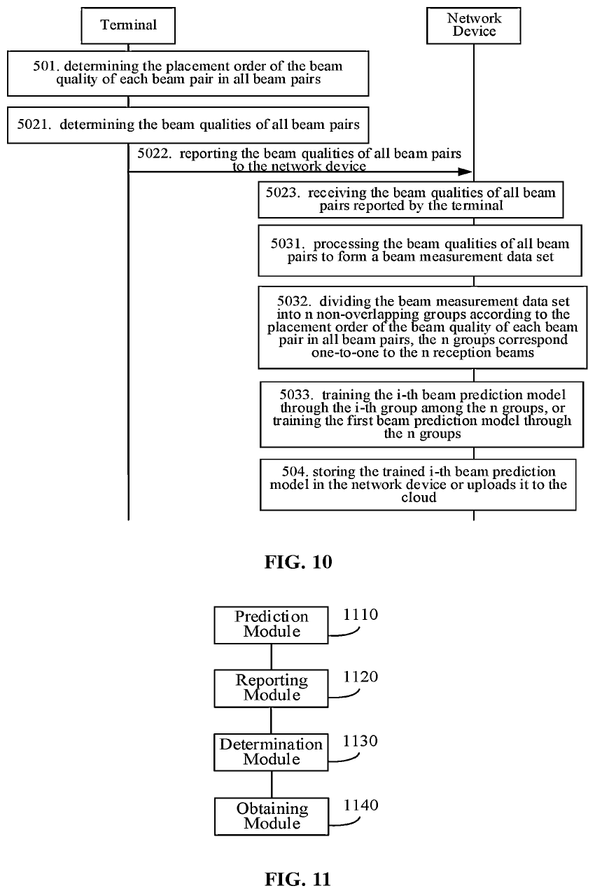

FIG. 10 shows a flowchart of beam prediction model training provided by an exemplary embodiment of the present application. The method is applied to the network device 01 and the terminal 02 in FIG. 1. The method includes:

Step 501: the terminal determining the placement order of the beam quality of each beam pair in all beam pairs.

According to the above content, for the convenience of query, the terminal can sort the placement order of the beam quality of each beam pair in all beam pairs. Taking the example that the terminal has n reception beams and the network device has m transmission beams, the terminals can be grouped according to the reception beams.

Optionally, step 501 may be implemented as follows:

Under each of the n reception beams, traverse the m transmission beams in sequence to form m×n beam pair identification IDs; and

According to the beam pair ID table formed by m×n beam pair IDs, the placement order of the beam qualities of all beam pairs is determined.

For example, under each of the n reception beams, the corresponding m transmission beams are traversed in turn to form a beam pair ID, wherein each beam pair ID corresponds to a reception beam of a terminal and a transmission beam of a network device, and the i-th beam pair ID corresponds to the beam quality of the i-th beam pair.

Illustratively, after determining the placement order of the beam qualities of each beam pair in all beam pairs, a beam pair ID table may be obtained, and the beam pair ID table may refer to the aforementioned content.

Schematically, the placement order is used to indicate the correspondence between all beam pairs and beam qualities, indicating the association between different beams. Taking the beam pair ID table as an example, according to the beam pair ID table, the terminal and/or network device can determine the placement position of the beam quality of each beam pair, as well as the reception beam and transmission beam corresponding to each beam pair. Schematically, during the training process of the first beam prediction model and the prediction process of the beam quality, the beam qualities of all beam pairs should be placed according to the beam pair ID table to facilitate query by the terminal and/or network device.

Step S021: the terminal determining the beam qualities of all beam pairs.

Schematically, a beam pair includes a reception beam of a terminal and a transmission beam of a network device, the transmission beam of the network device is any one of multiple transmission beams of the network device, and the reception beam of the terminal is the first reception beam or any one of n reception beams of the terminal, and the beam quality is used to train a first beam prediction model.

On each of the n reception beams, the terminal performs beam measurement on the corresponding transmission beam to obtain the beam quality of each transmission beam, and marks it as the beam quality of the corresponding beam pair.

Optionally, beam measurement for a transmission beam is performed based on a CSI-RS or SSB reference signal.

Step S022: the terminal reporting the beam qualities of all beam pairs to the network device.

Step S023: the network device receiving the beam qualities of all beam pairs reported by the terminal.

Schematically, a beam pair includes a reception beam of a terminal and a transmission beam of a network device, the transmission beam of the network device is any transmission beam among multiple transmission beams of the network device, and the reception beam of the terminal is the first reception beam or any reception beam among n reception beams of the terminal.

In the embodiment, the relevant description of the beam pair can be referred to the above content and will not be repeated here.

Optionally, the beam prediction method provided in an embodiment of the present application also includes: the terminal reporting a measurement timestamp and/or beam pair ID table to the network device; and the network device receiving the measurement timestamp and/or beam pair ID table reported by the terminal.

In the embodiment, the measurement timestamp is used to indicate the time when the terminal performs beam measurement, and the beam pair ID table is used to indicate the relative position of each beam pair among all beam pairs; the relevant description of the beam pair ID table can be referred to the above content and will not be repeated here.

After receiving the beam qualities of all beam pairs reported by the terminal, the network device can train the first beam prediction model accordingly. In the foregoing, the description of the first beam prediction model is expanded in step 3012. The following is an implementation method for training n beam prediction models:

Step S031: the network device processing the beam qualities of all beam pairs to form a beam measurement data set.

In an illustrative manner, the beam measurement data set is used to train n beam prediction models, and the beam prediction data set includes at least the beam quality of each beam pair. When the network device receives the beam quality of all beam pairs reported by the terminal, the measurement timestamp and the beam pair ID table, the beam prediction data set includes the beam quality of each beam pair, the time when the terminal performs beam measurement on each beam pair, and the relative position of each beam pair among all beam pairs.

In the embodiment, the relevant description of the beam quality of all beam pairs can be referred to the above content and will not be repeated here.

Step S032: the network device dividing the beam measurement data set into n non-overlapping groups according to the placement order of the beam quality of each beam pair in all beam pairs.

Schematically, the n groups correspond one-to-one to the n reception beams.

In the case where the i-th beam prediction model corresponds to the i-th reception beam among the n reception beams, each group is used to independently train each corresponding beam prediction model to improve the accuracy of model training, and the first group among the n groups corresponds to the first reception beam, and the first group is used to train the first beam prediction model. In the case where the first beam prediction model corresponds to each reception beam among the n reception beams, the n groups are used to train a beam prediction model (i.e., the first beam prediction model provided in the present application).

In the embodiment, the determination of the placement order of the beam quality of each beam pair in all beam pairs is implemented by the terminal, and the specific determination process can refer to the above content.

Schematically, the placement order is used to indicate the correspondence between all beam pairs and beam qualities, indicating the association between different beams. Taking the beam pair ID table as an example, according to the beam pair ID table, the terminal and/or network device can determine the placement position of the beam quality of each beam pair, as well as the reception beam and transmission beam corresponding to each beam pair. Schematically, during the training process of the first beam prediction model and the prediction process of the beam quality, the beam qualities of all beam pairs must be placed according to the beam pair ID table to facilitate query by the terminal and/or network device.

Taking the network device receiving the beam pair ID table reported by the terminal as an example, the network device can locate the corresponding relationship between the reception beam and the transmission beam according to the beam pair ID table. Taking the case where the terminal has n reception beams and the network device has m transmission beams as an example, the network device can divide the beam measurement data set into n groups according to the different reception beams according to the beam pair ID table, and the measurement data in each group are not intersecting.

Step S033: the network device training the i-th beam prediction model through the i-th group among the n groups, or training the first beam prediction model through the n groups.

After the beam measurement data set is grouped, the network device can train a beam prediction model corresponding to each reception beam according to each group.

Optionally, step S033 may be implemented as follows:
determining a model structure and model parameters of a first beam prediction model; and
training the i-th beam prediction model through the i-th group, or training the first beam prediction model through the first group.

In the embodiment, the relevant description of the model structure and model parameters of the first beam prediction model can refer to the aforementioned content.

According to the foregoing, the first beam prediction model is a beam prediction model corresponding to the first reception beam, or the first beam prediction model is a beam prediction model corresponding to each of the n reception beams. According to different corresponding relationships, the training process of the first beam prediction model is different.

Exemplarily, the network device may train the i-th beam prediction model through the i-th group among the n groups, where the i-th beam prediction model is the beam prediction model corresponding to the i-th reception beam. Taking the first beam prediction model as an example, the training of the first beam prediction model by the network device according to the first group may be described as follows:

The network device selects beam qualities of a fixed number of beam pairs from the first group as inputs of a first beam prediction model according to a sampling rate of beam measurement. For a description of the sampling rate, reference can be made to the aforementioned content.

Correspondingly, the output result of the first beam prediction model is the predicted value of the beam quality of the remaining transmission beams corresponding to the first reception beam; the label value is the true value of the beam quality of all beam pairs, which is obtained from the beam quality data set.

The network device then calculates the training loss value based on the model output results and label value information.

For example, the mean square error loss function is used to calculate the training loss value:

$$loss = \frac{1}{I} {\sum }_{i = 1}^{I} {( {y}_{i} - {\overline{y}}_{i} )}^{2} .$$

In the embodiment, l represents the amount of model training data, yᵢ represents the output result of data i after the model, and y̅ᵢ; represents the label value of data i.

Subsequently, the network device updates the model parameters for each beam based on the training loss value, model update method, and selected hyperparameters, such as using stochastic gradient descent (SGD) or Adam algorithm (Adaptive momentum) to update the parameters of a specific model layer.

Take the SGD algorithm to update the parameters of the beam pair grouping model as an example:

$${x}_{t + 1}^{k} = {x}_{t}^{k} - {α}_{t}^{k} * ∇ {loss}_{t}^{k} .$$

In the embodiment, ×ₜ^{k} represents the beam pair grouping model parameters to be updated in the t-th round, xₜ₊₁^{k} represents the beam pair grouping model parameters after the t-th round update, ∇lossₜ^{k} represents the gradient of the training loss value calculated in the t-th round, and aₜ^{k} represents the learning rate in the t-th round.

Exemplarily, the network device may train the first beam prediction model through n groups. The training of the first beam prediction model by the network device according to the n groups may be described as follows:

The network device selects beam qualities of a fixed number of beam pairs from the n groups according to a sampling rate of beam measurement as inputs of a first beam prediction model. For a description of the sampling rate, reference can be made to the aforementioned content.

Correspondingly, the output result of the first beam prediction model is the predicted value of the beam quality of the remaining transmission beams corresponding to the n reception beams; the label value is the true value of the beam quality of all beam pairs, which is obtained from the beam quality data set.

In the embodiment, the training loss value of the first beam prediction model and the update of the model parameters are similar to the above content and will not be repeated here.

Step 504: the network device storing the trained i-th beam prediction model in the network device or uploads it to the cloud.

The network device saves the i-th beam prediction model in the network device or uploads it to the cloud, so that the terminal or network device can obtain the beam prediction model corresponding to each reception beam, so as to facilitate beam prediction of part of the transmission beam of each reception beam.

Illustratively, in an embodiment of the present application, the steps on the terminal side may independently become an embodiment of the beam prediction method, and the steps on the network device side may independently become an embodiment of the beam prediction method. The specific explanation of the steps of the beam prediction method and the steps of the sending method can refer to the above content and will not be repeated here.

In summary, the beam prediction method provided in the embodiment of the present application also provides an implementation method for training a beam prediction model.

It should be understood that the multiple embodiments provided in the present application can be implemented in combination. For example, the network device side trains n beam prediction models and stores them in the network device: the terminal obtains the first beam prediction model from the network device to predict the beam quality of the second transmission beam based on the first reception beam. For another example, the network device side trains n beam prediction models and uploads them to the cloud; the network device downloads the i-th beam prediction model from the cloud to predict the beam quality of some transmission beams based on the i-th reception beam.

Taking the case where the terminal has n reception beams and the network device has m transmission beams as an example, an implementation of a beam prediction method is given below. The method is implemented by the terminal and the network device, and the method includes the following steps:

Step 1: the terminal determining the placement order of the beam quality of each beam pair in all beam pairs, performing beam measurement on all beam pairs, and reporting the beam quality of all beam pairs to the network device.

Furthermore, step 1 includes the following steps:

Step 110: the terminal determining the placement order of the beam qualities of each beam pair in all beam pairs.

Schematically, the terminal traverses m transmission beams in turn under each of the n reception beams to form m×n beam pair IDs; according to the beam pair ID table formed by the m×n beam pair IDs, the placement order of the beam qualities of all beam pairs is determined.

Each beam pair ID corresponds to a reception beam of a terminal and a transmission beam of a network device, and the i-th beam pair ID corresponds to the beam quality of the i-th beam pair.

Schematically, the placement order is used to indicate the correspondence between all beam pairs and beam qualities, indicating the association between different beams; during the training process of the first beam prediction model and the prediction process of the beam quality, the beam qualities of all beam pairs must be placed according to the beam pair ID table to facilitate query by the terminal and/or network device.

Step 120: the terminal determining the beam qualities of all beam pairs.

Schematically, a beam pair includes a reception beam of a terminal and a transmission beam of a network device, the transmission beam of the network device is any transmission beam among multiple transmission beams of the network device, and the reception beam of the terminal is the first reception beam or any reception beam among n reception beams of the terminal, and the beam quality is used to train a beam prediction model.

On each of the n reception beams, the terminal performs beam measurement on the corresponding transmission beam to obtain the beam quality of each transmission beam, and marks it as the beam quality of the corresponding beam pair.

Optionally, the beam measurement for the transmission beam is performed based on a CSI-RS or SSB reference signal. During the process of the network device performing transmission beam scanning, the network device sends a CSI-RS or SSB reference signal to the terminal; the terminal measures the reference signal and obtains the beam quality of the transmission beam direction by calculating the signal quality of the reference signal.

Optionally, the terminal selects L1-RSRP or L1-SINR as a criterion for judging the quality of the reference signal.

Step 130: the terminal reporting the beam qualities of all beam pairs to the network device.

Optionally, the terminal can also report the measurement timestamp and/or beam pair ID table to the network device.

In the embodiment, the measurement timestamp is used to indicate the time when the terminal performs beam measurement, and the beam pair ID table is used to indicate the relative position of each beam pair among all beam pairs; the relevant description of the beam pair ID table can be referred to the above content and will not be repeated here.

Step 2: the network device training the beam prediction model according to the beam qualities of all beam pairs.

Furthermore, step 2 includes the following steps:

Step 210: the network device processing the beam qualities of all beam pairs to form a beam measurement data set.

Schematically, the beam measurement data set is used to train n beam prediction models, and the beam prediction data set includes at least the beam quality of each beam pair. When the network device receives the beam quality of all beam pairs reported by the terminal, the measurement timestamp and the beam pair ID table, the beam prediction data set includes the beam quality of each beam pair, the time when the terminal performs beam measurement on each beam pair, and the relative position of each beam pair among all beam pairs. When the beam measurement for the transmission beam is based on the CSI-RS or SSB reference signal, the i-th beam pair ID in the beam pair 1D table is used to indicate the reference signal quality measured on the i-th beam pair.

Step 220: the network device dividing the beam measurement data set into n non-overlapping groups according to the placement order of the beam quality of each beam pair in all beam pairs.

Schematically, the n groups correspond to the n reception beams one by one, wherein the first group among the n groups corresponds to the first reception beam.

Taking the example that the terminal corresponds to n reception beams and the network device corresponds to m transmission beams, the network device can divide the beam measurement data set into n groups according to the different reception beams based on the beam pair ID table, and the measurement data in each group are non-intersecting.

Step 230: the network device and the terminal determining the sampling rate of beam measurement.

The sampling rate is a value greater than 0 and not greater than 1.

When using the trained model for beam prediction, the network device only needs to measure the beam quality of some beam pairs to restore the beam quality of all beam pairs. Assume that the total number of beam pairs to be measured between the terminal and the network device is C, and the sampling rate of beam measurement is k (0<k<l), that is, the terminal selects kC beam pairs from C beam pairs, measures the signal quality on these beam pairs and reports them to the network device, and does not measure other beam pairs that have not been selected to reduce resource overhead.

Step 240: the network device determining the model structure and model parameters of each grouping model.

In the embodiment, the relevant description of the model structure and model parameters of the beam prediction model can be referred to the above content and will not be repeated here.

Step 250: the network device using the measurement data included in each group to train the corresponding beam prediction model.

In the embodiment, the i-th beam prediction model corresponds to the i-th reception beam among the n reception beams. The training process of the i-th beam prediction model can refer to the aforementioned content and will not be repeated here.

Step 260: After completing the model training, the network device saving the trained beam prediction model in the network device or uploading it to the cloud.

Step 3: the terminal or network device performs prediction processing based on different beam prediction models to obtain the beam quality on all reception beams.

Furthermore, step 3 further includes the following steps:

Step 310: the terminal performing beam measurement on part of the transmission beams based on each reception beam.

Taking the first reception beam as an example, the terminal uses the first reception beam to perform beam measurement on the first transmission beam to obtain the beam quality of the first transmission beam. The first transmission beam includes one or more transmission beams corresponding to the first reception beam.

For example, the terminal selects a fixed number of transmission beams from the m transmission beams corresponding to each reception beam according to the sampling rate k of the beam measurement, and measures the quality of the reference signals to obtain the beam quality of the fixed number of transmission beams.

Step 320: the terminal or network device performing beam prediction using the trained beam prediction model.

Optionally, when beam prediction is implemented through the terminal, the terminal obtains different beam prediction models from the network device side or the cloud side: then, based on each reception beam, the terminal uses the corresponding beam prediction model and takes the beam quality of a fixed number of transmission beams as the model input to restore the beam quality of other transmission beams on each reception beam; then, the terminal reports the beam quality on all reception beams to the network device.

Optionally, when beam prediction is implemented by a network device, the terminal reports the beam quality of a fixed number of transmission beams to the network device; based on each reception beam, the network device uses the corresponding beam prediction model, takes the beam quality of a fixed number of transmission beams as model input, and recovers the beam quality of other transmission beams on each reception beam. If the beam prediction model is stored in the cloud, the network device needs to download the corresponding beam prediction model from the cloud.

Step 330: the network device obtaining the beam qualities of all reception beams.

The beam quality of all reception beams refers to the beam quality of all beam pairs shown in the aforementioned multiple embodiments.

Step 4: the network device determining the optimal beam pair and indicates the target transmission beam corresponding to the optimal beam pair to the terminal.

Further, step 4 includes the following steps:

Step 410: the network device integrating the beam qualities of all beam pairs.

For example, the network device sorts the beam qualities of all beam pairs according to the placement order of the beam qualities of all beam pairs to form the beam qualities of all beam pairs.

Step 420: the network device selecting the best beam pair from all beam pairs.

Exemplarily, the network device selects the beam pair 1D with the best quality from the beam qualities of all beam pairs, and determines the beam pair corresponding to the beam pair ID as the optimal beam pair.

In the embodiment, the relevant description of the optimal beam pair can be referred to the above content and will not be repeated here.

Step 430: the network device indicating to the terminal the target transmission beam corresponding to the optimal beam.

Exemplarily, the network device indicates the target transmission beam (i.e., reference signal) corresponding to the optimal beam pair to the terminal; the terminal uses it as the downlink transmission beam for beam management.

To summarize, in the beam prediction method provided in the embodiment of the present application, the network device independently trains a beam prediction model for each of the n reception beams based on the beam qualities of all beam pairs reported by the terminal; the terminal or network device can restore the beam qualities of all beam pairs based on the beam qualities of some transmission beams of the terminal based on different beam prediction models, thereby avoiding the terminal from performing beam measurements on all transmission beams. While ensuring the performance of beam management, the number of beam measurements is reduced, thereby reducing the overhead and delay of beam management, and reducing the complexity of beam management.

In addition, taking into account the differences in different reception beams, each beam prediction model is only used to predict the beam quality of part of the transmission beam under the corresponding reception beam, thereby improving the accuracy of beam prediction. At the same time, it can also flexibly adapt to the measurement method of the terminal and adjust the input and output of the model to meet diverse service needs.

It should be understood that the beam prediction method provided in the embodiment of the present application requires the terminal to report beam measurement data in a unified data format to the network device, and may also report a beam pair ID table to facilitate model group training. In addition, the network device needs to maintain a beam prediction model for each reception beam. The model structure and model parameters of each beam prediction model are not completely consistent and need to be adjusted according to specific needs. At the same time, the network device needs to update the beam prediction model at every predetermined time interval to ensure the accuracy of the beam prediction.

The following is an embodiment of the device of the present application. For details not described in detail in the embodiment of the device, reference can be made to the corresponding records in the above method embodiment, and they will not be repeated herein,

FIG. 11 shows a schematic diagram of a beam prediction apparatus provided by an exemplary embodiment of the present application, the apparatus including:
a prediction module 1110 configured to input a beam quality of a first transmission beam obtained based on a first reception beam into a first beam prediction model, and obtaining a beam quality of a second transmission beam based on the first reception beam through the first beam prediction model, wherein the first reception beam is one of n reception beams of the terminal, and the first transmission beam comprises one or more transmission beams corresponding to the first reception beam; and
a reporting module 1120 configured to report a beam quality of at least one transmission beam in the first transmission beam and the second transmission beam to a network device.

Optionally, the apparatus further includes a determination module 1130, configured to perform beam measurement on the first transmission beam using the first reception beam, to obtain the beam quality of the first transmission beam.

Optionally, the determination module 1130 is further configured to determine a number of the first transmission beam according to a sampling rate of beam measurement and a total number of beam pairs, each beam pair comprising a transmission beam of the network device and a reception beam of the terminal, and the total number of beam pairs is the product of a total number of transmission beams of the network device and a total number of reception beams of the terminal; or, determine the number of the first transmission beam according to the sampling rate of the beam measurement and the total number of transmission beams of the network device.

Optionally, the sampling rate is a value greater than 0 and not greater than 1.

Optionally, the a determination module 1130 is further configured to determine a target transmission beam indicated by the network device as a downlink transmission beam, wherein the target transmission beam corresponds to an optimal beam pair, and the optimal beam pair is determined according to a beam quality of at least one transmission beam in the first transmission beam and the second transmission beam.

Optionally, the apparatus further includes an obtaining module 1140, configured to obtain the first beam prediction model, wherein the first beam prediction model is stored in the network device or in a cloud.

Optionally, the a determination module 1130 is further configured to determine beam qualities of all beam pairs, wherein one beam pair comprises one reception beam of the terminal and one transmission beam of the network device, the one transmission beam of the network device is any one transmission beam of multiple transmission beams of the network device, and the one reception beam of the terminal is the first reception beam or any one reception beam of n reception beams of the terminal, and the beam qualities are used to train the first beam prediction model; and the reporting module 1120 is further configured to report the beam qualities of all the beam pairs to the network device.

Optionally, the determination module 1130 is configured to perform beam measurement on all transmission beams of the network device using the first reception beam of the terminal, to obtain the beam qualities corresponding to each beam pair; or, perform beam measurement on all transmission beams of the network device respectively using each reception beam of the terminal, to obtain the beam qualities corresponding to each beam pair.

Optionally, the beam measurement on the transmission beam is performed based on a channel state information reference signal CSI-RS or a synchronization signal block SSB reference signal.

Optionally, the determination module 1130 is further configured to: determine a placement order of the beam qualities of each beam pair among all the beam pairs.

Optionally, the determination module 1130 is configured to: under each of the n reception beams, traverse m transmission beams in sequence to form m×n beam pair identification IDs; and determine the placement order of the beam qualities of all the beam pairs according to a beam pair ID table formed by the m×n beam pair IDs.

Optionally, the reporting module 1120 is further configured to: report a measurement timestamp and/or a beam pair ID table to the network device.

Optionally, the first beam prediction model is a beam prediction model corresponding to the first reception beam.

Optionally, the transmission beams comprised in the first transmission beam and the second transmission beam are all transmission beams in the network device corresponding to the first reception beam.

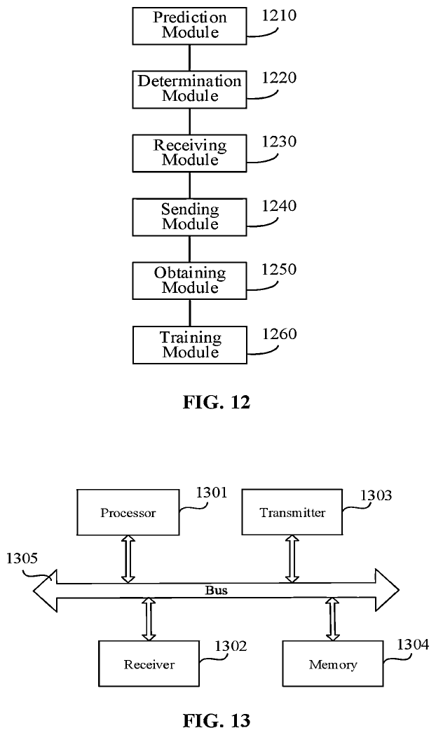

FIG. 12 shows a schematic diagram of a beam prediction apparatus provided by an exemplary embodiment of the present application, the apparatus including:
a prediction module 1210, configured to input a beam quality of a first transmission beam obtained based on a first reception beam into a first beam prediction model, and obtaining a beam quality of a second transmission beam based on the first reception beam through the first beam prediction model, wherein the first reception beam is one of n reception beams of a terminal, and the first transmission beam comprises one or more transmission beams corresponding to the first reception beam; and
a determination module 1220, configured to determine a target transmission beam according to a beam quality of at least one transmission beam in the first transmission beam and the second transmission beam.

Optionally, the apparatus further includes a receiving module 1230, configured to receive the beam quality of the first transmission beam reported by a terminal, wherein the beam quality of the first transmission beam is obtained by the terminal by performing beam measurement on the first transmission beam using the first reception beam.

Optionally, a number of the first transmission beam is determined according to a sampling rate of beam measurement and a total number of beam pairs, each beam pair comprising a transmission beam of the network device and a reception beam of the terminal, and the total number of beam pairs is the product of a total number of transmission beams of the network device and a total number of reception beams of the terminal; or, the number of the first transmission beam is determined according to the sampling rate of beam measurement and the total number of transmission beams of the network device.

Optionally, the sampling rate is a value greater than 0 and not greater than 1.

Optionally, the beam measurement on the transmission beam is performed based on a channel state information reference signal CSI-RS or a synchronization signal block SSB reference signal.

Optionally, the determination module 1220 is configured to: integrate beam qualities of the first transmission beam and the second transmission beam respectively corresponding to each of the n reception beams to obtain beam qualities of all beam pairs; and determine the transmission beam corresponding to the beam pair with best beam quality among all the beam pairs as the target transmission beam.

Optionally, the determination module 1220 is configured to: sort the beam qualities of the first transmission beam and the second transmission beam according to the placement order of the beam qualities of all beam pairs.

Optionally, the apparatus also includes: a sending module 1240, configured to indicate a target transmission beam to the terminal, and the target transmission beam is used by the terminal to determine a downlink transmission beam and/or a downlink reception beam.

Optionally, the apparatus further includes: an obtaining module 1250, configured to obtain a first beam prediction model, wherein the first beam prediction model is stored in the cloud.

Optionally, the receiving module 1230 is further configured to receive beam qualities of all beam pairs reported by the terminal, where a beam pair includes a reception beam of the terminal and a transmission beam of the network device, the transmission beam of the network device is any one of multiple transmission beams of the network device, and the reception beam of the terminal is the first reception beam among the n reception beams of the terminal or any one of the n reception beams of the terminal; the apparatus further includes a training module 1260, which is configured to train a first beam prediction model based on the beam qualities of all beam pairs.

Optionally, the training module 1260 is configured to: perform data processing on the beam qualities of all beam pairs to form a beam measurement data set; divide the beam measurement data set into n non-overlapping groups according to the placement order of the beam qualities of each beam pair in all beam pairs, and the u groups correspond one-to-one to the n reception beams; train the i-th beam prediction model through the i-th group among the n groups, or train the first beam prediction model through the n groups.

Optionally, the training module 1260 is configured to: determine the model structure and model parameters of the first beam prediction model; and train the first beam prediction model using the measurement data included in the first group.

Optionally, the training module 1260 is further configured to: store the trained i-th beam prediction model in the network device, or upload it to the cloud.

Optionally, the receiving module 1230 is further configured to: receive a measurement timestamp and/or beam pair ID table reported by the terminal.

Optionally, the first beam prediction model is a beam prediction model corresponding to the first reception beam.

Optionally, the transmission beams included in the first transmission beam and the second transmission beam are all transmission beams in the network device that correspond to the first reception beam.

FIG. 13 shows a schematic diagram of the structure of a communication device (terminal or network device) provided by an exemplary embodiment of the present application. The communication device includes: a processor 1301, a receiver 1302, a transmitter 1303, a memory 1304 and a bus 1305.

The processor 1301 includes one or more processing cores. The processor 1301 executes various functional applications and information processing by running software programs and modules.

The receiver 1302 and the transmitter 1303 may be implemented as a communication component, which may be a communication chip.

The memory 1304 is connected to the processor 1301 via the bus 1305.

The memory 1304 may be used to store at least one instruction, and the processor 1301 may be used to execute the at least one instruction to implement the various steps of the beam prediction method mentioned in the above method embodiment.

In addition, the memory 1304 can be implemented by any type of volatile or non-volatile storage device or a combination thereof. The volatile or non-volatile storage device includes but is not limited to: a magnetic disk or an optical disk, an electrically erasable programmable read-only memory (EEPROM), an erasable programmable read-only memory (EPROM), a static random access memory (SRAM), a read-only memory (ROM), a magnetic memory, a flash memory, and a programmable read-only memory (PROM).

An embodiment of the present application also provides a terminal, which includes a processor and a transceiver; the processor is configured to input the beam quality of the first transmission beam obtained based on the first reception beam into the first beam prediction model, and obtain the beam quality of the second transmission beam based on the first reception beam through the first beam prediction model, the first reception beam is one of the n reception beams of the terminal, and the first transmission beam includes one or more transmission beams corresponding to the first reception beam; the transceiver is used to report the beam quality of at least one of the first transmission beam and the second transmission beam to the network device.

An embodiment of the present application also provides a network device, which includes a processor; the processor is configured to input the beam quality of a first transmission beam obtained based on a first reception beam into a first beam prediction model, and obtain the beam quality of a second transmission beam based on the first reception beam through the first beam prediction model, wherein the first reception beam is one of n reception beams of the terminal, and the first transmission beam includes one or more transmission beams corresponding to the first reception beam; and determine an optimal beam pair based on the beam quality of at least one transmission beam of the first transmission beam and the second transmission beam.

An embodiment of the present application further provides a computer-readable storage medium, in which a computer program is stored. The computer program is used to be executed by a processor to implement the beam prediction method as described above.

An embodiment of the present application further provides a chip, which includes a programmable logic circuit and/or program instructions, and when the chip is running, is used to implement the beam prediction method as described above.

An embodiment of the present application also provides a computer program product, which includes computer instructions. The computer instructions are stored in a computer-readable storage medium. A processor reads and executes the computer instructions from the computer-readable storage medium to implement the beam prediction method as described above.

The embodiments of the present application provide a beam prediction method, apparatus, device and storage medium, which can determine the beam quality of the second transmission beam by inputting the beam quality of the first transmission beam into the first beam prediction model, thereby avoiding the terminal from performing beam measurement on all transmission beams, reducing the number of beam measurements, thereby reducing the overhead and delay of beam management, and reducing the complexity of beam management. The technical solution is as follows:

According to one aspect of the present application, a beam prediction method is provided, which is applied to a terminal, and the method includes:
inputting a beam quality of a first transmission beam obtained based on a first reception beam into a first beam prediction model, and obtaining a beam quality of a second transmission beam based on the first reception beam through the first beam prediction model, wherein the first reception beam is one of n reception beams of the terminal, and the first transmission beam includes one or more transmission beams corresponding to the first reception beam; and
reporting abeam quality of at least one transmission beam in the first transmission beam and the second transmission beam to a network device.

According to one aspect of the present application, a beam prediction method is provided, which is applied to a network device, and the method includes:
inputting a beam quality of a first transmission beam obtained based on a first reception beam into a first beam prediction model, and obtaining a beam quality of a second transmission beam based on the first reception beam through the first beam prediction model, wherein the first reception beam is one of n reception beams of a terminal, and the first transmission beam includes one or more transmission beams corresponding to the first reception beam;
determining a target transmission beam according to a beam quality of at least one transmission beam in the first transmission beam and the second transmission beam.

According to one aspect of the present application, a beam prediction apparatus is provided, which includes:
a predicting module, configured to input a beam quality of a first transmission beam obtained based on a first reception beam into a first beam prediction model, and obtaining a beam quality of a second transmission beam based on the first reception beam through the first beam prediction model, wherein the first reception beam is one of n reception beams of a terminal, and the first transmission beam includes one or more transmission beams corresponding to the first reception beam; and
a sending module, configured to report abeam quality of at least one transmission beam in the first transmission beam and the second transmission beam to the network device.

According to one aspect of the present application, a beam prediction apparatus is provided, which includes.
a predicting module, configured to input a beam quality of a first transmission beam obtained based on a first reception beam into a first beam prediction model, and obtaining a beam quality of a second transmission beam based on the first reception beam through the first beam prediction model, wherein the first reception beam is one of n reception beams of a terminal, and the first transmission beam includes one or more transmission beams corresponding to the first reception beam; and
a determining module, configured to determine a target transmission beam according to a beam quality of at least one transmission beam in the first transmission beam and the second transmission beam.

According to one aspect of the present application, a terminal is provided, the terminal including a processor and a transceiver;
the processor is configured to input a beam quality of a first transmission beam obtained based on a first reception beam into a first beam prediction model, and obtaining a beam quality of a second transmission beam based on the first reception beam through the first beam prediction model, wherein the first reception beam is one of n reception beams of the terminal, and the first transmission beam includes one or more transmission beams corresponding to the first reception beam; and
the transceiver is configured to report a beam quality of at least one transmission beam in the first transmission beam and the second transmission beam to the network device.

According to one aspect of the present application, a network device is provided, the network device including a processor;
the processor is configured to input a beam quality of a first transmission beam obtained based on a first reception beam into a first beam prediction model, and obtaining a beam quality of a second transmission beam based on the first reception beam through the first beam prediction model, wherein the first reception beam is one of n reception beams of a terminal, and the first transmission beam includes one or more transmission beams corresponding to the first reception beam, and
determine a target transmission beam according to a beam quality of at least one transmission beam in the first transmission beam and the second transmission beam.

According to one aspect of the present application, a computer-readable storage medium is provided, in which a computer program is stored. The computer program is used to be executed by a processor to implement the beam prediction method as described above.

According to one aspect of the present application, a chip is provided, which includes a programmable logic circuit and/or program instructions, and when the chip is running, it is used to implement the beam prediction method as described above.

According to one aspect of the present application, a computer program product or a computer program is provided, the computer program product or the computer program including computer instructions, the computer instructions being stored in a computer-readable storage medium, and a processor reading and executing the computer instructions from the computer-readable storage medium to implement the beam prediction method as described above.

The technical solution provided by the embodiments of the present application includes at least the following beneficial effects:

By inputting the beam quality of the first transmission beam into the first beam prediction model, the terminal or the network device can determine the beam quality of the second transmission beam, so that the network device determines the target transmission beam according to a beam quality of at least one transmission beam in the first transmission beam and the second transmission beam. In the present application, the terminal only needs to perform beam measurement on the first transmission beam, avoiding the terminal from performing beam measurement on all transmission beams, reducing the number of beam measurements, thereby reducing the overhead and delay of beam management, and reducing the complexity of beam management.

The above description is only an optional embodiment of the present application and is not intended to limit the present application. Any modifications, equivalent substitutions, improvements, etc. made within the spirit and principles of the present application shall be included in the protection scope of the present application.

The invention claimed is:

1. A beam prediction method, applied to a terminal, the method comprising:
inputting a beam quality of a first transmission beam obtained based on a first reception beam into a first beam prediction model, and obtaining a beam quality of a second transmission beam based on the first reception beam through the first beam prediction model, wherein the first reception beam is one of n reception beams of the terminal, and the first transmission beam comprises one or more transmission beams corresponding to the first reception beam; and
reporting a beam quality of at least one transmission beam in the first transmission beam and the second transmission beam to a network device.

2. The method according to claim 1, further comprising:
performing beam measurement on the first transmission beam using the first reception beam, to obtain the beam quality of the first transmission beam.

3. The method according to claim 2, further comprising:
determining a number of the first transmission beam according to a sampling rate of beam measurement and a total number of beam pairs, each beam pair comprising a transmission beam of the network device and a reception beam of the terminal, and the total number of beam pairs is the product of a total number of transmission beams of the network device and a total number of reception beams of the terminal;
or, determining the number of the first transmission beam according to the sampling rate and the total number of transmission beams of the network device.

4. (canceled)

5. The method according to claim 1, further comprising:
determining a target transmission beam indicated by the network device as a downlink transmission beam, wherein the target transmission beam corresponds to an optimal beam pair, and the optimal beam pair is determined according to a beam quality of at least one transmission beam in the first transmission beam and the second transmission beam.

6. (canceled)

7. The method according to any one of claim 1, further comprising:
determining beam qualities of all beam pairs, wherein one beam pair comprises one reception beam of the terminal and one transmission beam of the network device, the one transmission beam of the network device is any one transmission beam of multiple transmission beams of the network device, and the one reception beam of the terminal is the first reception beam or any one reception beam of n reception beams of the terminal, and the beam qualities are used to train the first beam prediction model;
reporting the beam qualities of all the beam pairs to the network device; and
reporting at least one of a measurement timestamp or a beam pair ID table to the network device.

8. The method according to claim 7, wherein determining the beam qualities of all beam pairs comprises:
performing beam measurement on all transmission beams of the network device using the first reception beam of the terminal, to obtain the beam qualities corresponding to each beam pair; or
performing beam measurement on all transmission beams of the network device respectively using each reception beam of the terminal, to obtain the beam qualities corresponding to each beam pair.

9. (canceled)

10. The method according to claim 7, further comprising:
determining a placement order of the beam qualities of each beam pair among all the beam pairs,
wherein determining the placement order of the beam qualities of each beam pair among all the beam pairs comprises:
under each of the n reception beams, traversing in transmission beams in sequence to form m×n beam pair identification IDs; and
determining the placement order of the beam qualities of all the beam pairs according to a beam pair ID table formed by the m×n beam pair IDs.

11-12. (canceled)

13. The method according to claim 1, wherein the first beam prediction model is a beam prediction model corresponding to the first reception beam, or
wherein the transmission beams comprised in the first transmission beam and the second transmission beam are all transmission beams in the network device corresponding to the first reception beam.

14. (canceled)

15. A beam prediction method, performed by network device, the method comprising:
inputting a beam quality of a first transmission beam obtained based on a first reception beam into a first beam prediction model, and obtaining a beam quality of a second transmission beam based on the first reception beam through the first beam prediction model, wherein the first reception beam is one of n reception beams of a terminal, and the first transmission beam comprises one or more transmission beams corresponding to the first reception beam; and
determining a target transmission beam according to a beam quality of at least one transmission beam in the first transmission beam and the second transmission beam.

16. The method according to claim 15, further comprising:
receiving the beam quality of the first transmission beam reported by a terminal, wherein the beam quality of the first transmission beam is obtained by the terminal by performing beam measurement on the first transmission beam using the first reception beam.

17. The method according to claim 16, wherein:
a number of the first transmission beam is determined according to a sampling rate of beam measurement and a total number of beam pairs, each beam pair comprising a transmission beam of the network device and a reception beam of the terminal, and the total number of beam pairs is the product of a total number of transmission beams of the network device and a total number of reception beams of the terminal; or
the number of the first transmission beam is determined according to the sampling rate and the total number of transmission beams of the network device.

18-19. (canceled)

20. The method according to claim 15, wherein the determining the target transmission beam according to the beam quality of at least one transmission beam in the first transmission beam and the second transmission beam comprises:
integrating beam qualities of the first transmission beam and the second transmission beam respectively corresponding to each of the n reception beams to obtain beam qualities of all beam pairs; and
determining the transmission beam corresponding to the beam pair with best beam quality among all the beam pairs as the target transmission beam.

21. The method according to claim 15, further comprising:
indicating the target transmission beam to the terminal, and the target transmission beam is used by the terminal to determine a downlink transmission beam and/or a downlink reception beam.

22. The method according to claim 15, further comprising:
obtaining the first beam prediction model, wherein the first beam prediction model is stored in a cloud.

23. The method according to claim 15, further comprising:
receiving beam qualities of all beam pairs reported by the terminal, wherein one beam pair comprises one reception beam of the terminal and one transmission beam of the network device, the one transmission beam of the network device is any one transmission beam of multiple transmission beams of the network device, and the one reception beam of the terminal is the first reception beam of n reception beams of the terminal or any one reception beam of n reception beams of the terminal; and
training the first beam prediction model according to the beam qualities of all the beam pairs.

24. The method according to claim 23, wherein determining the beam qualities of all beam pairs comprises:
performing data processing on the beam qualities of all the beam pairs to form a beam measurement data set;
dividing the beam measurement data set into n non-overlapping groups according to a placement order of the beam quality of each beam pair among all the beam pairs, wherein the n groups correspond one-to-one to the n reception beams; and
training an i-th beam prediction model by an i-th group among the n groups, or training the first beam prediction module by the n groups.

25. (canceled)

26. The method according to claim 15, further comprising:
receiving a measurement timestamp and/or a beam pair ID table reported by the terminal.

27. The method according to claim 15, wherein the first beam prediction model is a beam prediction model corresponding to the first reception beam, or
wherein the transmission beams comprised in the first transmission beam and the second transmission beam are all transmission beams in the network device corresponding to the first reception beam.

28-30. (canceled)

31. A terminal comprising
a processor; and
a transceiver,
wherein the processor and the transceiver are configured to implement the beam prediction method according to claim 1.

32. A network device, comprising:
a processor; and
a memory storing instructions executable by the processor,
wherein the processor is configured to:
input a beam quality of a first transmission beam obtained based on a first reception beam into a first beam prediction model, and obtain a beam quality of a second transmission beam based on the first reception beam through the first beam prediction model, wherein the first reception beam is one of n reception beams of a terminal, and the first transmission beam comprises one or more transmission beams corresponding to the first reception beam; and
determine a target transmission beam according to a beam quality of at least one transmission beam in the first transmission beam and the second transmission beam.

33-35. (canceled)
